(19) United States
(12) Patent Application Publication
(10) Pub. No.: US 2023/0365143 A1
(43) Pub. Date: Nov. 16, 2023

(54) SYSTEM AND METHOD FOR REMOTE CONTROL GUIDED AUTONOMY FOR AUTONOMOUS VEHICLES

(71) Applicant: TuSimple, Inc., San Diego, CA (US)

(72) Inventors: Mehmet Ersin Yumer, Oakland, CA (US); Xiaodi Hou, San Diego, CA (US)

(21) Appl. No.: 18/192,043

(22) Filed: Mar. 29, 2023

Related U.S. Application Data
(60) Provisional application No. 63/364,531, filed on May 11, 2022.

(51) Int. Cl. B60W 50/029; B60W 50/02; B60W 60/00; B60W 30/14; B60W 30/16; B60W 30/12; G05D 1/00; G05D 1/02

(52) U.S. Cl. CPC B60W 50/029; B60W 50/0205; B60W 60/00186; B60W 30/143; B60W 30/16; B60W 30/12; G05D 1/0077; G05D 1/0038; G05D 1/0223; B60W 2050/0292; B60W 2300/145; B60W 2552/53; B60W 2554/80; B60W 2555/60; B60W 2556/50; G05D 2201/0213

(57) ABSTRACT

A system comprises an autonomous vehicle and a control device. The control device detects an event trigger that impacts the autonomous vehicle. In response, to detecting the event trigger, the control device enters the autonomous vehicle into a first degraded autonomy mode, In the first degraded autonomy mode, the control device communicates sensor data to an oversight server. The control device receives high-level commands from the oversight server. The one or more high-level commands indicate minimal risk maneuvers for the autonomous vehicle. The control device receives a maximum traveling speed for the autonomous vehicle from the oversight server. The control device navigates the autonomous vehicle using an adaptive cruise control according to the one or more high-level commands and the maximum traveling speed.

This application claims priority to U.S. Provisional Application No. 63/364,531 filed May 11, 2022, and titled “SYSTEM AND METHOD FOR REMOTE CONTROL GUIDED AUTONOMY FOR AUTONOMOUS VEHICLES,” which is incorporated herein by reference.

### TECHNICAL FIELD

The present disclosure relates generally to autonomous vehicles. More particularly, the present disclosure is related to a system and method for remote control guided autonomy for autonomous vehicles.

### BACKGROUND

In some cases, while traveling along a road, a component of an autonomous vehicle may malfunction. The malfunctioning component may impact the operation of an autonomous vehicle. At the sign of the malfunction, the autonomous vehicle is either abruptly forced to stop if the malfunction is severe or pulled over to a side of a road if the malfunction is less severe. These approaches may increase the potential for accidents with other vehicles.

### SUMMARY

This disclosure recognizes various problems and previously unmet needs related to navigating an autonomous vehicle in cases where a hardware failure and/or a software failure impacts the operation of autonomous vehicle. Certain embodiments of the present disclosure provide unique technical solutions to technical problems of current autonomous vehicle technologies, including those problems described above to implement various degraded autonomy modes for the autonomous vehicle depending on a situation.

The present disclosure contemplates systems and methods for implementing various degraded autonomy modes for the autonomous vehicle depending on a situation.

In an example scenario, assume that the autonomous vehicle is traveling along the road, and a control device associated with the autonomous vehicle detects an event trigger that impacts the autonomous vehicle. The event trigger may include a hardware failure and/or a software failure with respect to the autonomous vehicle.

The control device may enter the autonomous vehicle into a first degraded autonomy mode in cases where: 1) the wireless communication between the control device and an oversight server is at least partially operational (even with more than a threshold delay, e.g., more than half a second, a second, two seconds, etc.); 2) the lane detection capability and location detection capability of the control device is at least partially operational; 3) the traffic sign detection capability of the control device is at least partially operational; and 4) an adaptive cruise control is at least partially operational.

In the first degrade autonomy mode, the control device communicates sensor data (captured by sensors of the autonomous vehicle) to the oversight server, and in response, receives high-level commands and the maximum traveling speed from the oversight server.

The control device detects lane markings and traffic signs from the sensor data. The control device navigates the autonomous vehicle using the adaptive cruise control according to the high-level commands, the maximum traveling speed, lane markings, and traffic signs.

The control device may enter the autonomous vehicle into a second degraded autonomy mode in cases where: 1) the wireless communication between the control device and the oversight server is at least partially operational (even with more than a threshold delay, e.g., more than half a second, a second, two seconds, etc.); 2) the adaptive cruise control is at least partially operational; and 3) the control device is not capable of lane following or detecting traffic signs.

In the second degraded autonomy mode, the control device communicates sensor data (captured by sensors of the autonomous vehicle) to the oversight server, and in response, receives high-level commands and the maximum traveling speed from the oversight server. The control device navigates the autonomous vehicle using the adaptive cruise control according to the high-level commands, and the maximum traveling speed.

One difference between the second degraded autonomy mode and the first degraded autonomy mode is that the control device is less capable in its ability to navigate the autonomous vehicle due to not being capable of lane following and detecting traffic signs. Thus, the control device may receive the high-level commands more frequently in the second degraded autonomy mode compared to the first degraded autonomy mode.

In the first and the second degraded autonomy modes, up to a certain delay (e.g., up to two seconds delay, three seconds delay, etc.) in communication between the control device and the oversight server may be acceptable due to the degraded operation of the lane following and low traveling speed of the autonomous vehicle.

The control device may enter the autonomous vehicle into a third degraded autonomy mode in cases where: 1) there is no (or very poor) network communication between the control device and the oversight server; 2) the lane detection capability and location detection capability of the control device are at least partially operational; 3) the traffic sign detection capability of the control device is at least partially operational; and 4) the adaptive cruise control is at least partially operational.

For example, there may be no (or very poor) network communication between the control device and the oversight server due to the autonomous vehicle being in an area where the network coverage is non-existent or very poor (e.g., the network connection throughput speed is less than a threshold, such as 1 kilo byte per minute (kbpm), 2 kbpm.

In the third degraded autonomy mode, the control device determines lane markings and traffic signs from the sensor data. The control device navigates the autonomous vehicle using the adaptive cruise control according to a predefined maximum speed, lane markings, and traffic signs.

Thus, the disclosed system contemplates various degraded autonomy modes for various situations.

Accordingly, the disclosed system may be integrated into a practical application of improving navigation of autonomous vehicles and operations of the autonomous vehicles.

Furthermore, the disclosed system may be integrated into an additional practical application of improving the driving experience of the autonomous vehicle and other vehicles.

One potential approach in response to detecting a malfunctioning of a component of the autonomous vehicle, is to either abruptly stop the autonomous vehicle as fast as possible if a serious malfunction (e.g., loss of localization, loss of main compute unit, etc.) is detected or pull the autonomous vehicle to a predefined rescue area off the road if the detected malfunction is less severe. However, this approach does not address various situation described above and may cause potential accidents with other vehicles on the road. Thus, by not abruptly stopping the autonomous vehicle at a first sign or indication of malfunctioning, the autonomous vehicle can be navigated with or even without high-level commands from the oversight server. Therefore, the disclosed system may improve the driving experience of the autonomous vehicle and other vehicles.

In one embodiment, a system comprises an autonomous vehicle and a control device associated with the autonomous vehicle. The autonomous vehicle is configured to travel along a road, wherein the autonomous vehicle comprises at least one sensor configured to capture sensor data. The control device comprises a processor configured to detect an event trigger that impacts the autonomous vehicle. In response to detecting the event trigger, the processor is further configured to enter the autonomous vehicle into a first degraded autonomy mode. In the first degraded autonomy mode, the processor is configured to communicate the sensor data to an oversight server. The processor receives one or more high-level commands from the oversight server, where the one or more high-level commands indicate minimal risk maneuvers for the autonomous vehicle. The processor receives a maximum traveling speed for the autonomous vehicle from the oversight server. The processor navigates the autonomous vehicle using an adaptive cruise control according to the one or more high-level commands and the maximum traveling speed.

Certain embodiments of this disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an embodiment of a system for implementing various degraded autonomy modes for autonomous vehicles;

FIG. 2 illustrate an example operational flow of the system of FIG. 1 for implementing a first degraded autonomy mode;

FIG. 3 illustrate an example operational flow of the system of FIG. 1 for implementing a second degraded autonomy mode;

FIG. 4 illustrate an example operational flow of the system of FIG. 1 for implementing a third degraded autonomy mode;

FIG. 5 illustrates an embodiment of a method for implementing a first degraded autonomy mode for autonomous vehicles;

FIG. 6 illustrates an embodiment of a method for implementing a second degraded autonomy mode for autonomous vehicles;

FIG. 7 illustrates an embodiment of a method for implementing a third degraded autonomy mode for autonomous vehicles;

FIG. 8 illustrates an embodiment of a method for implementing various degraded autonomy modes for autonomous vehicles;

FIG. 9 illustrates a block diagram of an example autonomous vehicle configured to implement autonomous driving operations;

FIG. 10 illustrates an example system for providing autonomous driving operations used by the autonomous vehicle of FIG. 9; and

FIG. 11 illustrates a block diagram of an in-vehicle control computer included in the autonomous vehicle of FIG. 9.

### DETAILED DESCRIPTION

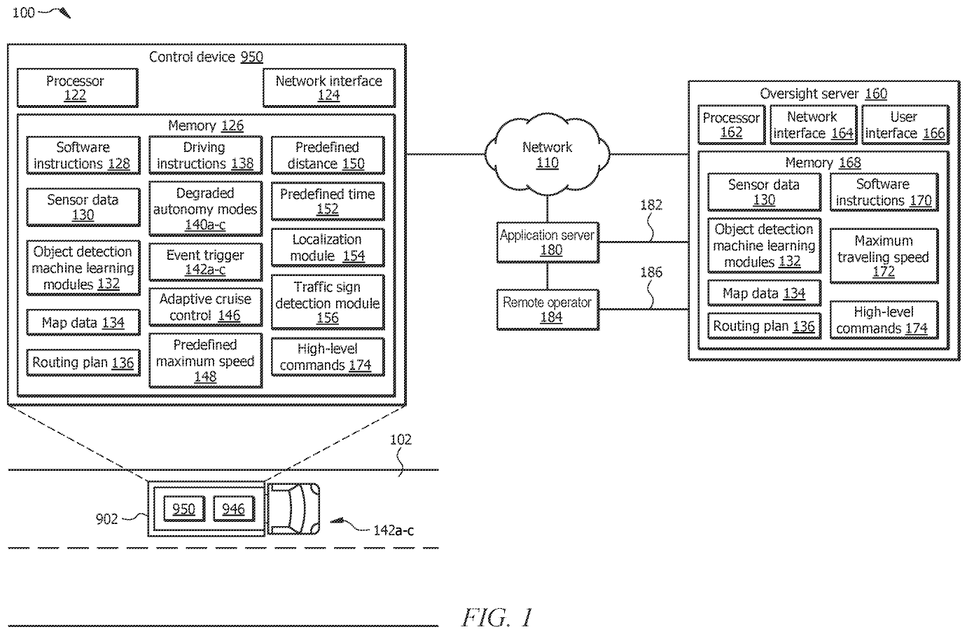

As described above, previous technologies fail to provide efficient, reliable, and safe solutions to navigate an autonomous vehicle in cases where a hardware failure and/or a software failure impacts the operation of the autonomous vehicle. The present disclosure provides various systems, methods, and devices to implement various degraded autonomy modes for the autonomous vehicle depending on a situation. Embodiments of the present disclosure and its advantages may be understood by referring to FIGS. 1 through 11. FIGS. 1 through 11 are used to describe a system and method to implement various degraded autonomy modes for the autonomous vehicle depending on a situation.

### System Overview

FIG. 1 illustrates an embodiment of a system 100 configured to implement various degraded autonomy modes 140a-c to address various hardware and/or software failures with respect to an autonomous vehicle 902. FIG. 1 further illustrates a simplified schematic of a road 102 traveled by the autonomous vehicle 902 where the autonomous vehicle 902 may enter any of the degraded autonomy modes 140a-c depending on a detected event trigger 142a-c that impacts the autonomous vehicle 902. In certain embodiments, system 100 comprises an autonomous vehicle 902 communicatively coupled with an oversight server 160 and an application server 180 via a network 110. Network 110 enables communications among components of the system 100. Network 110 allows the autonomous vehicle 902 to communicate with other autonomous vehicles 902, systems, oversight server 160, application server 180, databases, devices, etc. The autonomous vehicle 902 comprises a control device 950. Control device 950 comprises a processor 122 in signal communication with a memory 126. Memory 126 stores software instructions 128 that when executed by the processor 122, cause the control device 950 to perform one or more operations described herein. Oversight server 160 comprises a processor 162 in signal communication with a memory 168. Memory 168 stores software instructions 170 that when executed by the processor 162, cause the oversight server 160 to perform one or more operations described herein. In other embodiments, system 100 may not have all of the components listed and/or may have other elements instead of, or in addition to, those listed above. System 100 may be configured as shown or in any other configuration.

In an example scenario, assume that the autonomous vehicle 902 is traveling along the road 102, and a control device 950 detects an event trigger 142 (e.g., one or more event triggers 142a-c) that impacts the autonomous vehicle 902. The event trigger 142a-c may include a hardware failure and/or a software failure with respect to the autonomous vehicle 902. For example, a hardware and/or a software module of the autonomous vehicle 902 may fail or be degraded.

The failed or degraded hardware and/or software modules of the autonomous vehicle 902 may be associated with various functions of the autonomous vehicle 902, such as localization of the autonomous vehicle 902 (e.g., determining a geographical positioning system (GPS) location of the autonomous vehicle 902 on a map data 134), object detection (e.g., detecting objects and obstacles on the road 102, such as traffic signs and lane markings), connectivity with the oversight server 160, among others.

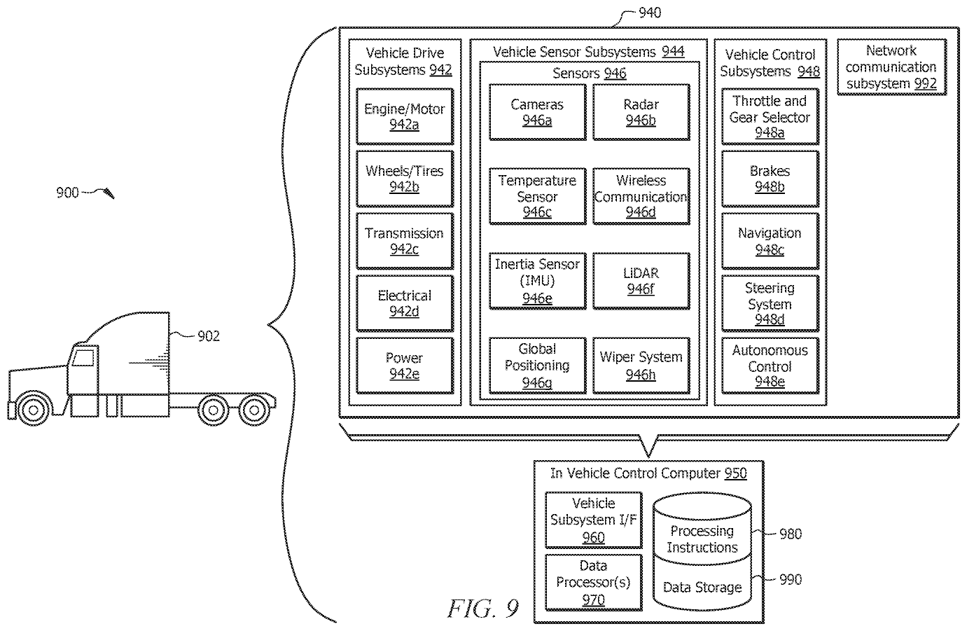

A failed or degraded hardware module of the autonomous vehicle 902 may include a sensor 946 that is damaged, e.g., as a result of an impact, a computing unit (e.g., any of the subsystems 940 described in FIG. 9), and/or any other hardware module of the autonomous vehicle 902 that is not fully functional. Faulty connectors on-bard the autonomous vehicle 902 may interrupt the transfer of data and other information, causing an event trigger 142 (e.g., one or more event triggers 142a-c).

A failed or degraded software module of the autonomous vehicle 902 may include software code associated with any component of the autonomous vehicle 902 that may be corrupted, e.g., due to an software algorithm error or a bug in the code, due to a cyber-attack or other code hack. For example, the failed or degraded software module may include software instructions 128, object detection machine algorithm modules 132, a localization module 154, traffic sign detection module 156, among other software modules.

The control device 950 may determine that a hardware failure and/or a software failure in response to detecting that a health level of at least one component of the autonomous vehicle 902 has become less than a threshold percentage, e.g., less than 60%, 50%, etc.

In response to detecting a hardware failure and/or a software failure, one potential approach is to either abruptly stop the autonomous vehicle 902 as fast as possible if a serious malfunction (e.g., loss of localization, loss of main compute unit, etc.) is detected or pull the autonomous vehicle 902 to a predefined rescue area off the road 102 if the detected malfunction is less severe. In other words, the existing solutions only address two extreme cases, where in one case, the autonomous vehicle 902 is forced to stop, and in another case the autonomous vehicle 902 is pulled over. However, this approach does not address various scenarios between these two extreme cases and suffers from several drawbacks.

For example, the gap in such a mechanism is such that if the autonomous vehicle 902 is not in one of the predefined less severe malfunctioning states, it is forced to stop on the road 102. This approach may cause potential accidents with other vehicles on the road 102. Especially on a highway, it is not expected for an autonomous vehicle 902 to stop on the road unless it is mechanically non-operational. In most cases where degraded or failed hardware and/or software modules are detected, the autonomous vehicle 902 is pulled into an emergency lane or the nearest rescue area by a driver. This may not be possible of the autonomous vehicle 902 if there are no drivers around the autonomous vehicle 902 to manually operate the autonomous vehicle 902.

Another potential approach is streaming the sensor data 130 to the oversight server 160, displaying the sensor data 130 (e.g., a video feed of the road 102 ahead of the autonomous vehicle 902) on the user interface 166, and allowing the remote operator 184 to remotely navigate the autonomous vehicle 902. However, this potential approach suffers from limitations of available network communication bandwidth between the control device 950 and the oversight server 160, especially in certain areas where the wireless network coverage is limited or even non-existent. This may lead to a significant delay in transmission and streaming the sensor data 130.

To provide technical solutions to these drawbacks, the system 100 is configured to implement various degraded autonomy modes 140a-c for various scenarios and address cases between the two extreme cases of stopping and pulling over the autonomous vehicle 902 described above.

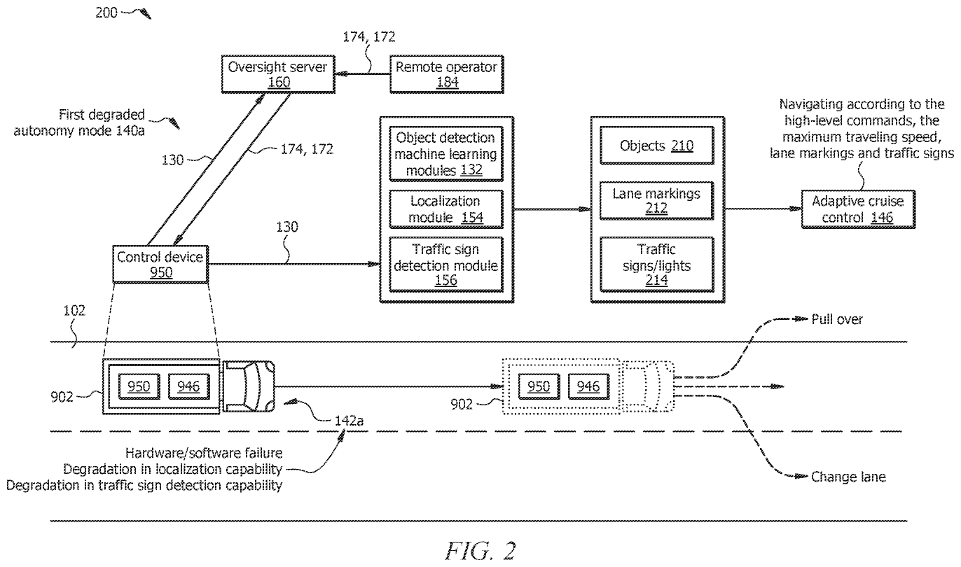

In a first case, assume that the control device 950 is capable of performing: 1) communicating (e.g., streaming) the sensor data 130 to the oversight server 160 (even with more than a threshold delay, e.g., more than half a second, a second, two seconds, etc.); 2) receiving data from the oversight server 160 (e.g., the maximum traveling speed 172 and high-level commands 174); 3) detecting lanes and lane markings; 4) detecting traffic signs and traffic lights; and 5) navigating the autonomous vehicle 902 using an adaptive cruise control 146 according to the data received from the oversight server 160, detected lane markings, traffic signs, and traffic lights. In this case, control device 950 is configured to enter the autonomous vehicle 902 into a first degraded autonomy mode 140a. The first degraded autonomy mode 140a is described in greater detail below in conjunction with an operational flow 200 of system 100 described in FIG. 2.

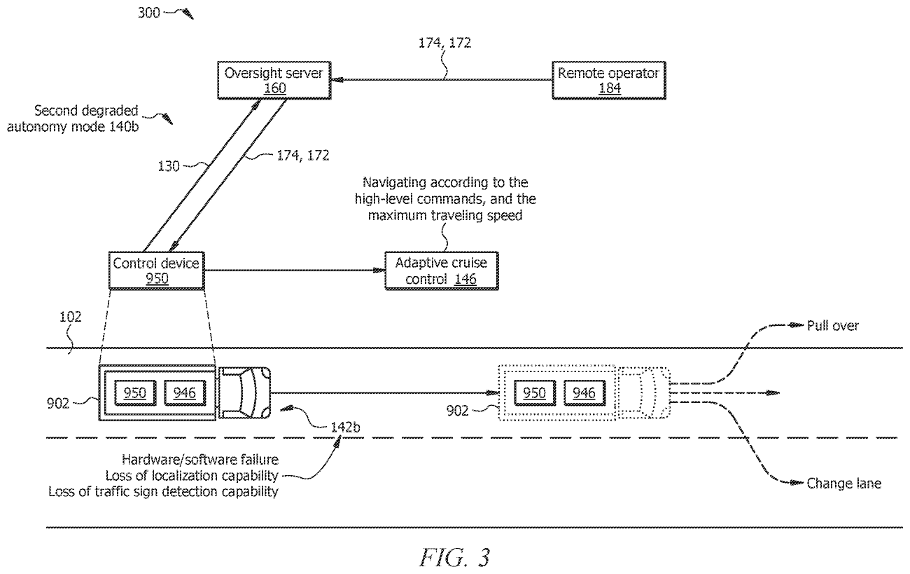

In a second case, assume that the control device 950 is capable of performing: 1) communicating (e.g., streaming) the sensor data 130 to the oversight server 160 (even with more than a threshold delay, e.g., more than half a second, a second, two seconds, etc.); 2) receiving data from the oversight server 160 (e.g., the maximum traveling speed 172 and high-level commands 174); and 3) navigating the autonomous vehicle 902 using an adaptive cruise control 146 according to the data received from the oversight server 160. In this case, control device 950 is configured to enter the autonomous vehicle 902 into a second degraded autonomy mode 140b. The second degraded autonomy mode 140b is described in greater detail below in conjunction with an operational flow 300 of system 100 described in FIG. 3.

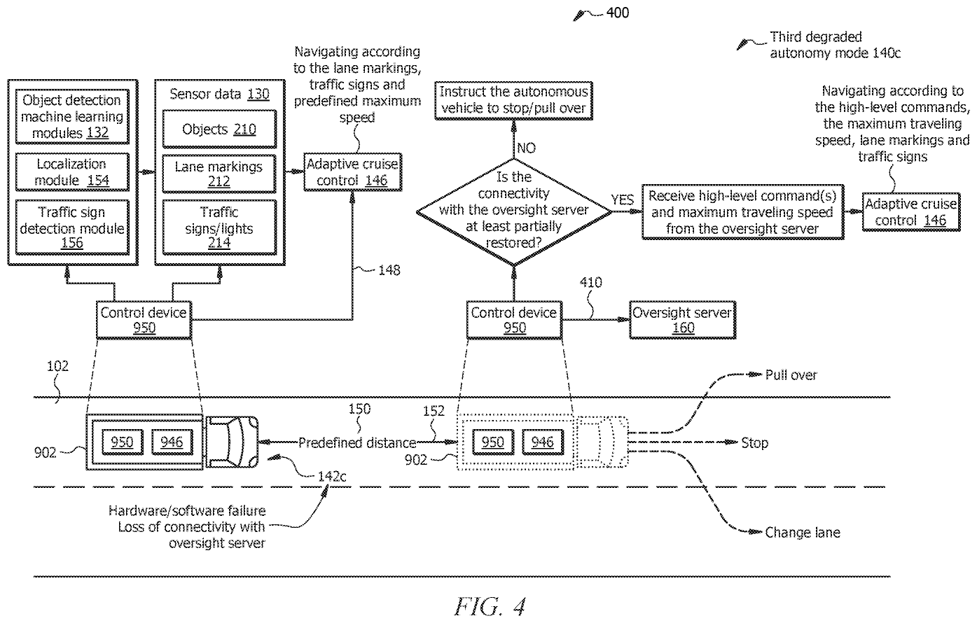

In a third case, assume that the control device 950 is capable of performing: 1) detecting lanes and lane markings; 2) detecting traffic signs and traffic lights; and 3) navigating the autonomous vehicle 902 using an adaptive cruise control 146 according to the detected lanes, lane markings, traffic signs, and traffic lights. In this case, control device 950 is configured to enter the autonomous vehicle 902 into a third degraded autonomy mode 140c. The third degraded autonomy mode 140c is described in greater detail below in conjunction with an operational flow 400 of system 100 described in FIG. 4.

### System Components

Network 110 may include any interconnecting system capable of transmitting audio, video, signals, data, messages, or any combination of the preceding. Network 110 may include all or a portion of a local area network (LAN), a wide area network (WAN), a metropolitan area network (MAN), a personal area network (PAN), a wireless PAN (WPAN), an overlay network, a software-defined network (SDN), a virtual private network (VPN), a packet data network (e.g., the Internet), a mobile telephone network (e.g., cellular networks, such as 4G or 5G), a plain old telephone (POT) network, a wireless data network (e.g., WiFi, WiGig, WiMax, etc.), a long term evolution (LTE) network, a universal mobile telecommunications system (UMTS) network, a peer-to-peer (P2P) network, a Bluetooth network, a near field communication (NFC) network, a Zigbee network, a Z-wave network, a WiFi network, and/or any other suitable network.

### Example Autonomous Vehicle

In one embodiment, the autonomous vehicle 902 may include a semi-truck tractor unit attached to a trailer to transport cargo or freight from one location to another location (see FIG. 9). The autonomous vehicle 902 is generally configured to travel along a road in an autonomous mode. The autonomous vehicle 902 may navigate using a plurality of components described in detail in FIGS. 9-11. The operation of the autonomous vehicle 902 is described in greater detail in FIGS. 9-11. The corresponding description below includes brief descriptions of certain components of the autonomous vehicle 902.

Control device 950 may be generally configured to control the operation of the autonomous vehicle 902 and its components and to facilitate autonomous driving of the autonomous vehicle 902. The control device 950 may be further configured to determine a pathway in front of the autonomous vehicle 902 that is safe to travel and free of objects or obstacles, and navigate the autonomous vehicle 902 to travel in that pathway. This process is described in more detail in FIGS. 9-11. The control device 950 may generally include one or more computing devices in signal communication with other components of the autonomous vehicle 902 (see FIG. 9). In this disclosure, the control device 950 may interchangeably be referred to as an in-vehicle control computer 950.

The control device 950 may be configured to detect objects on and around a road traveled by the autonomous vehicle 902 by analyzing the sensor data 130 and/or map data 134. For example, the control device 950 may detect objects on and around the road by implementing object detection machine learning modules 132. The object detection machine learning modules 132 may be implemented using neural networks and/or machine learning algorithms for detecting objects from images, videos, infrared images, point clouds, radar data, etc. The object detection machine learning modules 132 are described in more detail further below. The control device 950 may receive sensor data 130 from the sensors 946 positioned on the autonomous vehicle 902 to determine a safe pathway to travel. The sensor data 130 may include data captured by the sensors 946.

Sensors 946 may be configured to capture any object within their detection zones or fields of view, such as landmarks, lane markers, lane boundaries, road boundaries, vehicles, pedestrians, road/traffic signs, among others. In some embodiments, the sensors 946 may be configured to detect rain, fog, snow, and/or any other weather condition. The sensors 946 may include a detection and ranging (LiDAR) sensor, a radar sensor, a video camera, an infrared camera, an ultrasonic sensor system, a wind gust detection system, a microphone array, a thermocouple, a humidity sensor, a barometer, an inertial measurement unit, a positioning system, an infrared sensor, a motion sensor, a rain sensor, and the like. In some embodiments, the sensors 946 may be positioned around the autonomous vehicle 902 to capture the environment surrounding the autonomous vehicle 902. See the corresponding description of FIG. 9 for further description of the sensors 946.

### Control Device

The control device 950 is described in greater detail in FIG. 9. In brief, the control device 950 may include the processor 122 in signal communication with the memory 126 and a network interface 124. The processor 122 may include one or more processing units that perform various functions as described herein. The memory 126 may store any data and/or instructions used by the processor 122 to perform its functions. For example, the memory 126 may store software instructions 128 that when executed by the processor 122 causes the control device 950 to perform one or more functions described herein.

The processor 122 may be one of the data processors 970 described in FIG. 9. The processor 122 comprises one or more processors operably coupled to the memory 126. The processor 122 may be any electronic circuitry, including state machines, one or more central processing unit (CPU) chips, logic units, cores (e.g., a multi-core processor), field-programmable gate arrays (FPGAs), application-specific integrated circuits (ASICs), or digital signal processors (DSPs). The processor 122 may be a programmable logic device, a microcontroller, a microprocessor, or any suitable combination of the preceding. The processor 122 may be communicatively coupled to and in signal communication with the network interface 124 and memory 126. The one or more processors may be configured to process data and may be implemented in hardware or software. For example, the processor 122 may be 8-bit, 16-bit, 32-bit, 64-bit, or of any other suitable architecture. The processor 122 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The one or more processors may be configured to implement various instructions. For example, the one or more processors may be configured to execute software instructions 128 to implement the functions disclosed herein, such as some or all of those described with respect to FIGS. 1-11. In some embodiments, the function described herein is implemented using logic units, FPGAs, ASICs, DSPs, or any other suitable hardware or electronic circuitry.

Network interface 124 may be a component of the network communication subsystem 992 described in FIG. 9. The network interface 124 may be configured to enable wired and/or wireless communications. The network interface 124 may be configured to communicate data between the autonomous vehicle 902 and other devices, systems, or domains. For example, the network interface 124 may comprise an NFC interface, a Bluetooth interface, a Zigbee interface, a Z-wave interface, a radio-frequency identification (RFID) interface, a WIFI interface, a local area network (LAN) interface, a wide area network (WAN) interface, a metropolitan area network (MAN) interface, a personal area network (PAN) interface, a wireless PAN (WPAN) interface, a modem, a switch, and/or a router. The processor 122 may be configured to send and receive data using the network interface 124. The network interface 124 may be configured to use any suitable type of communication protocol as would be appreciated by one of ordinary skill in the art.

The memory 126 may be one of the data storages 990 described in FIG. 9. The memory 126 may be volatile or non-volatile and may comprise read-only memory (ROM), random-access memory (RAM), ternary content-addressable memory (TCAM), dynamic random-access memory (DRAM), and static random-access memory (SRAM). The memory 126 may include one or more of a local database, cloud database, network-attached storage (NAS), etc. The memory 126 may store any of the information described in FIGS. 1-11 along with any other data, instructions, logic, rules, or code operable to implement the function(s) described herein when executed by processor 122. For example, the memory 126 may store software instructions 128, sensor data 130, object detection machine learning module 132, map data 134, routing plan 136, driving instructions 138, degraded autonomy modes 140a-c, event triggers 142a-c, high-level commands 174, adaptive cruise control 146, predefined maximum speed 148, predefined distance 150, predefined time 152, localization module 154, traffic sign detection module 156, and/or any other data/instructions. The software instructions 128 include code that when executed by the processor 122 causes the control device 950 to perform the functions described herein, such as some or all of those described in FIGS. 1-11. The memory 126 comprises one or more disks, tape drives, or solid-state drives, and may be used as an over-flow data storage device to store programs when such programs are selected for execution, and to store instructions and data that are read during program execution.

Object detection machine learning modules 132 may be implemented by the processor 122 executing software instructions 128, and may be generally configured to detect objects and obstacles from the sensor data 130. The object detection machine learning modules 132 may be implemented using neural networks and/or machine learning algorithms for detecting objects from any data type, such as images, videos, infrared images, point clouds, Radar data, etc.

In some embodiments, the object detection machine learning modules 132 may be implemented using machine learning algorithms, such as Support Vector Machine (SVM), Naive Bayes, Logistic Regression, k-Nearest Neighbors, Decision Trees, or the like. In some embodiments, the object detection machine learning modules 132 may utilize a plurality of neural network layers, convolutional neural network layers, Long-Short-Term-Memory (LSTM) layers, Bi-directional LSTM layers, recurrent neural network layers, and/or the like, in which weights and biases of these layers are optimized in the training process of the object detection machine learning modules 132. The object detection machine learning modules 132 may be trained by a training dataset that may include samples of data types labeled with one or more objects in each sample. For example, the training dataset may include sample images of objects (e.g., vehicles, lane markings, pedestrians, road signs, obstacles, etc.) labeled with object(s) in each sample image. Similarly, the training dataset may include samples of other data types, such as videos, infrared images, point clouds, Radar data, etc. labeled with object(s) in each sample data. The object detection machine learning modules 132 may be trained, tested, and refined by the training dataset and the sensor data 130. The object detection machine learning modules 132 use the sensor data 130 (which are not labeled with objects) to increase their accuracy of predictions in detecting objects. For example, supervised and/or unsupervised machine learning algorithms may be used to validate the predictions of the object detection machine learning modules 132 in detecting objects in the sensor data 130.

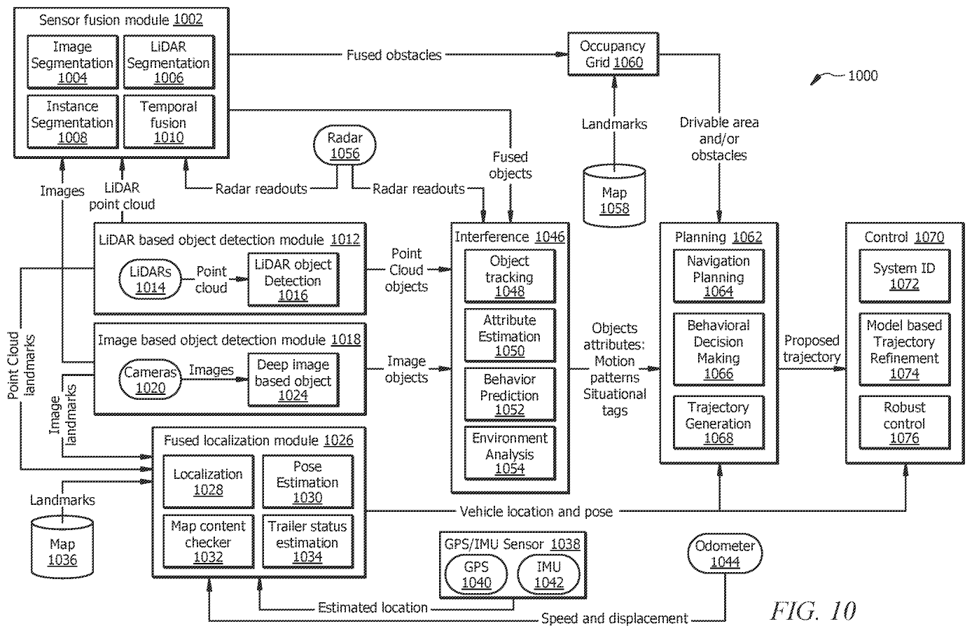

Map data 134 may include a virtual map of a city or an area that includes the road traveled by an autonomous vehicle 902. In some examples, the map data 134 may include the map 1058 and map database 1036 (see FIG. 10 for descriptions of the map 1058 and map database 1036). The map data 134 may include drivable areas, such as roads, paths, highways, and undrivable areas, such as terrain (determined by the occupancy grid module 1060, see FIG. 10 for descriptions of the occupancy grid module 1060). The map data 134 may specify location coordinates of road signs, lanes, lane markings, lane boundaries, road boundaries, traffic lights, obstacles, etc.

Routing plan 136 may be a plan for traveling from a start location (e.g., a first autonomous vehicle launchpad/landing pad) to a destination (e.g., a second autonomous vehicle launchpad/landing pad). For example, the routing plan 136 may specify a combination of one or more streets, roads, and highways in a specific order from the start location to the destination. The routing plan 136 may specify stages, including the first stage (e.g., moving out from a start location/launch pad), a plurality of intermediate stages (e.g., traveling along particular lanes of one or more particular street/road/highway), and the last stage (e.g., entering the destination/landing pad). The routing plan 136 may include other information about the route from the start position to the destination, such as road/traffic signs in that routing plan 136, etc.

Driving instructions 138 may be implemented by the planning module 1062 (See descriptions of the planning module 1062 in FIG. 10.). The driving instructions 138 may include instructions and rules to adapt the autonomous driving of the autonomous vehicle 902 according to the driving rules of each stage of the routing plan 136. For example, the driving instructions 138 may include instructions to stay within the speed range of a road traveled by the autonomous vehicle 902, adapt the speed of the autonomous vehicle 902 with respect to observed changes by the sensors 946, such as speeds of surrounding vehicles, objects within the detection zones of the sensors 946, etc.

Adaptive cruise control 146 may be implemented by the processor 122 executing software instructions 128, and generally configured to navigate the autonomous vehicle 902 according to a given data/instructions, such as a predefined maximum traveling speed 148, the maximum traveling speed 172, and the high-level commands 174. The control device 950 may use the adaptive cruise control 146 to keep a safe distance from other objects and vehicles (e.g., six feet, seven feet, or any other suitable distance) and keep the autonomous vehicle 902 in the current lane it is traveling in. Example navigations of the autonomous vehicle 902 using the adaptive cruise control 146 are described in in FIGS. 2-5.

Localization module 154 may correspond to the fused localization module 1026 (See description of the fused localization module 1026 in FIG. 10.). The localization module 154 may be implemented by the processor 122 executing software instructions 128, and generally configured to determine a location of the autonomous vehicle 902 on a road 102 and/or on the map data 134. Thus, the localization module 154 may provide the location detection capability. The control device 950 may use the localization module 154 for lane following, e.g., staying in a current lane. The localization module 154 may use data captured by a GPS sensor 946g (see FIG. 9) to determine the location of the autonomous vehicle 902.

Traffic sign detection module 156 may be implemented by the processor 122 executing software instructions 128, and generally configured to detect road signs, traffic signs, traffic lights, and the like. In certain embodiments, the traffic sign detection module 156 may be implemented using neural networks and/or machine learning algorithms configured to detect road signs, traffic signs, traffic lights, and the like. In some embodiments, the traffic sign detection module 156 may be implemented using machine learning algorithms, such as Support Vector Machine (SVM), Naive Bayes, Logistic Regression, k-Nearest Neighbors, Decision Trees, or the like. In some embodiments, the traffic sign detection module 156 may utilize a plurality of neural network layers, convolutional neural network layers, Long-Short-Term-Memory (LSTM) layers, Bi-directional LSTM layers, recurrent neural network layers, and/or the like, in which weights and biases of these layers are optimized in the training process of the traffic sign detection module 156. The traffic sign detection module 156 may be trained by a training dataset that comprises a plurality of images of road signs, traffic signs, and traffic lights, each labeled with the sampled data. Similarly, the training dataset may include samples of other data types, such as videos, infrared images, point clouds, Radar data, etc. labeled with road sign, traffic sign, or traffic light in each sample data. The traffic sign detection module 156 may be trained, tested, and refined by the training dataset and the sensor data 130. The traffic sign detection module 156 uses the sensor data 130 (which are not labeled with road sign, traffic sign, and traffic light) to increase their accuracy of predictions in detecting objects. For example, supervised and/or unsupervised machine learning algorithms may be used to validate the predictions of the traffic sign detection module 156 in detecting road signs, traffic signs, and traffic lights in the sensor data 130.

### Oversight Server

Oversight server 160 may include one or more processing devices and is generally configured to oversee the operations of the autonomous vehicle 902 while they are in transit and oversee traveling of the autonomous vehicle 902. The oversight server 160 may comprise a processor 162, a network interface 164, a user interface 166, and a memory 168. The components of the oversight server 160 are operably coupled to each other. The processor 162 may include one or more processing units that perform various functions of the oversight server 160. The memory 168 may store any data and/or instructions used by the processor 162 to perform its functions. For example, the memory 168 may store software instructions 170 that when executed by the processor 162 cause the oversight server 160 to perform one or more functions described herein. The oversight server 160 may be configured as shown or in any other suitable configuration.

In one embodiment, the oversight server 160 may be implemented by a cluster of computing devices that may serve to oversee the operations of the autonomous vehicle 902. For example, the oversight server 160 may be implemented by a plurality of computing devices using distributed computing and/or cloud computing systems. In another example, the oversight server 160 may be implemented by a plurality of computing devices in one or more data centers. As such, in one embodiment, the oversight server 160 may include more processing power than the control device 950. The oversight server 160 is in signal communication with the autonomous vehicle 902 and its components (e.g., the control device 950).

Processor 162 comprises one or more processors. The processor 162 may be any electronic circuitry, including state machines, one or more CPU chips, logic units, cores (e.g., a multi-core processor), FPGAs, ASICs, or DSPs. The processor 162 may be a programmable logic device, a microcontroller, a microprocessor, or any suitable combination of the preceding. The processor 162 may be communicatively coupled to and in signal communication with the network interface 164, user interface 166, and memory 168. The one or more processors are configured to process data and may be implemented in hardware or software. For example, the processor 162 may be 8-bit, 16-bit, 32-bit, 64-bit or of any other suitable architecture. The processor 162 may include an ALU for performing arithmetic and logic operations, processor registers that supply operands to the ALU and store the results of ALU operations, and a control unit that fetches instructions from memory and executes them by directing the coordinated operations of the ALU, registers and other components. The one or more processors are configured to implement various instructions. For example, the one or more processors are configured to execute software instructions 170 to implement the functions disclosed herein, such as some or all of those described with respect to FIGS. 1-11. In some embodiments, the function described herein may be implemented using logic units, FPGAs, ASICs, DSPs, or any other suitable hardware or electronic circuitry.

Network interface 164 may be configured to enable wired and/or wireless communications of the oversight server 160. The network interface 164 may be configured to communicate data between the oversight server 160 and other devices, servers, autonomous vehicles 902, systems, or domains. For example, the network interface 164 may comprise an NFC interface, a Bluetooth interface, a Zigbee interface, a Z-wave interface, an RFID interface, a WIFI interface, a LAN interface, a WAN interface, a PAN interface, a modem, a switch, and/or a router. The processor 162 may be configured to send and receive data using the network interface 164. The network interface 164 may be configured to use any suitable type of communication protocol as would be appreciated by one of ordinary skill in the art.

User interfaces 166 may include one or more user interfaces that are configured to interact with users, such as the remote operator 184. The remote operator 184 may access the oversight server 160 via the communication path 186. In certain embodiments, the user interfaces 166 may include peripherals of the oversight server 160, such as monitors, keyboards, mouse, trackpads, touchpads, microphones, webcams, speakers, and the like. In certain embodiments, the user interface 166 may include a graphical user interface, a software application, or a web application. The remote operator 184 may use the user interfaces 166 to access the memory 168 to review any data stored in the memory 168. The remote operator 184 may confirm, update, and/or override the routing plan 136 and/or any other data stored in memory 168.

Memory 168 may be volatile or non-volatile and may comprise ROM, RAM, TCAM, DRAM, and SRAM. The memory 168 may include one or more of a local database, cloud database, NAS, etc. Memory 168 may store any of the information described in FIGS. 1-11 along with any other data, instructions, logic, rules, or code operable to implement the function(s) described herein when executed by processor 162. For example, the memory 168 may store software instructions 170, sensor data 130, object detection machine learning module 132, map data 134, routing plan 136, maximum traveling speed 172, high-level commands 174, and/or any other data/instructions. The software instructions 170 may include code that when executed by the processor 162 causes the oversight server 160 to perform the functions described herein, such as some or all of those described in FIGS. 1-11. The memory 168 comprises one or more disks, tape drives, or solid-state drives, and may be used as an over-flow data storage device, to store programs when such programs are selected for execution, and to store instructions and data that are read during program execution.

### Application Server

The application server 180 may be any computing device configured to communicate with other devices, such as the oversight server 160, autonomous vehicles 902, databases, etc., via the network 110. The application server 180 may be configured to perform functions described herein and interact with the remote operator 184, e.g., via communication path 182 using its user interfaces. Examples of the application server 180 include, but are not limited to, desktop computers, laptop computers, servers, etc. In one example, the application server 180 may act as a presentation layer from which the remote operator 184 can access the oversight server 160. As such, the oversight server 160 may send the routing plan 136, sensor data 130, and/or any other data/instructions to the application server 180, e.g., via the network 110. The remote operator 184, after establishing the communication path 182 with the application server 180, may review the received data and confirm, update, and/or override any of the routing plan 136, for example.

The remote operator 184 may be an individual who is associated with and has access to the oversight server 160. For example, the remote operator 184 may be an administrator that can access and view the information regarding the autonomous vehicle 902, such as sensor data 130, driving instructions 138, routing plan 136, and other information that is available on the memory 168. In one example, the remote operator 184 may access the oversight server 160 from the application server 180 that is acting as a presentation layer via the network 110.

### Operational Flow for Implementing a First Degraded Autonomy Mode

FIG. 2 illustrates an example operational flow 200 of system 100 of FIG. 1 for implementing the first degraded autonomy mode 140a. FIG. 2 further illustrates a road 102 travelled by the autonomous vehicle 902 where the autonomous vehicle 902 enters the first degraded autonomy mode 140a.

In the first degraded autonomy mode 140a, it is assumed that: 1) the wireless communication between the control device 950 and the oversight server 160 is at least partially operational (even with more than a threshold delay, e.g., more than half a second, a second, two seconds, etc.); 2) the localization module 154 (that provides lane detection capability and location detection capability) of the control device 950 is at least partially operational; 3) the traffic sign detection module 156 (that provides traffic sign detection capability) of the control device 950 is at least partially operational; and 4) the adaptive cruise control 146 is at least partially operational.

In an example scenario, assume that the autonomous vehicle 902 is traveling along the road 102. The control device 950 may detect an event trigger 142a that impacts the autonomous vehicle 902.

In certain embodiments, the event trigger 142a may comprise one or more of a hardware and a software failure with respect to the autonomous vehicle 902, similar to that described in FIG. 1.

In certain embodiments, the event trigger 142a may comprise one or more of a hardware and a software degradation with respect to the autonomous vehicle 902, similar to that described in FIG. 1.

In certain embodiments, the event trigger 142a may comprise a degradation in a hardware module of the autonomous vehicle 902 such that the hardware and module is partially operational, e.g., due to malfunctioning of the hardware module.

In certain embodiments, the event trigger 142a may comprise a degradation in a software module of the autonomous vehicle 902 such that the software module is partially operational, e.g., due to a bug in the software module and/or the software module being corrupted.

In certain embodiments, the event trigger 142a may comprise a degradation that impacts a hardware component of the autonomous vehicle 902, such as a sensor 946 or any component in vehicle subsystems 940 (see FIG. 9) being damaged due to an impact.

In certain embodiments, the event trigger 142a may comprise a degradation that impacts a software component of the autonomous vehicle 902, such as the software instructions 128, object detection machine learning modules 132, localization module 154, and/or traffic sign detection module 156, e.g., due to the software module being out of date.

In certain embodiments, the event trigger 142a may comprise a degradation that impacts the network interface 124. The degradation that impacts the network interface 124 may be due to the autonomous vehicle 902 being in an area where there is limited network coverage, a hardware degradation with respect to the network interface 124, and/or a software degradation with respect to the network interface 124.

### Entering the autonomous vehicle into the first degraded autonomy mode

In response to detecting the event trigger 142a described above, the control device 950 enters the autonomous vehicle 902 into the first degraded autonomy mode 140a. In the first degraded autonomy mode 140a, the control device 950 may perform one or more of the following operations in parallel or in any suitable order.

The control device 950 may communicate sensor data 130 to the oversight server 160. The sensor data 130 may comprise data that indicate objects on and around the road 102, such as lane markings, traffic signs, traffic lights, other vehicles, and/or any other object. For example, the sensor data 130 may include a video feed captured by one or more cameras associated with the autonomous vehicle 902 (e.g., cameras 946a described in FIG. 9). In other examples, the sensor data 130 may include any other data captured by other sensors 946, such as an image feed, point cloud data feed, etc.

The oversight server 160 receives the sensor data 130. The oversight server 160 may display the sensor data 130 on the user interface 166 (see FIG. 1). The remote operator 184 may view the sensor data 130 either by accessing the oversight server 160 directly or via the application server 180 (see FIG. 1), similar to that described in FIG. 1.

The remote operator 184 may provide an input to the user interface 166 (see FIG. 1), where the input comprises one or more high-level commands 174 and the maximum traveling speed 172 for the autonomous vehicle 902. The one or more high-level commands 174 may indicate minimal risk maneuvers for the autonomous vehicle 902, such as slowing down the autonomous vehicle 902. The one or more high-level commands 174 may include one or more of the following instructions: 1) stay within a current lane for a particular amount of time (e.g., five minutes, six minutes, etc.); 2) change to a particular lane when traffic on the particular lane allows; 3) change to an emergency lane when traffic allows; 4) drive to a drivable safe area that is off of the main road 102; 5) take a particular exit; 6) pull over on a particular side of the road 102 at a particular location; and 7) drive until a particular distance and stop at a particular location.

The oversight server 160 may accept the input on the user interface 166 (see FIG. 1). The oversight server 160 may communicate the one or more high-level commands 174 and the maximum traveling speed 172 to the control device 950.

The control device 950 may receive the one or more high-level commands 174 and the maximum traveling speed 172 from the oversight server 160.

The control device 950 may implement the object detection machine learning modules 132, localization modules 154, and traffic sign detection modules 156. In this process, the control device 950 may feed the sensor data 130 to the object detection machine learning modules 132 to detect the objects 210 (and obstacles) on the road 102, such as other vehicles. The control device 950 may feed the sensor data 130 to the localization module 154 to detect the lane markings 212 on at least one or both sides of the autonomous vehicle 902 from the sensor data 130. As such, the control device 950 may keep the autonomous vehicle 902 within a current lane. The control device 950 may feed the sensor data 130 to the traffic sign detection module 156 to detect the traffic signs 214 (and traffic lights) on the road 102 ahead of the autonomous vehicle 902 from the sensor data 130.

The control device 950 may implement the adaptive cruise control 146 to navigate the autonomous vehicle 902. Using the adaptive cruise control 146 and modules described above, the control device 950 ensures that the autonomous vehicle 902 keeps a predefined safe distance between itself and other vehicles and objects on the road 102, does not crash into the other vehicles and objects, and does not steer out of a lane it is currently traveling in by detecting the lane markings on one or both sides of the autonomous vehicle 902.

The control device 950 may also ensure navigation of the autonomous vehicle 902 according to the traffic rules on the road 102 based on detecting and analyzing the traffic signs and traffic lights (if any) on the road 102 via the traffic sign detection module 156, unless overridden by the remote operator 184.

The control device 950 may navigate the autonomous vehicle 902 using the adaptive cruise control 146 according to the one or more high-level commands 174, the maximum traveling speed 172, the sensor data 130, lane markings, traffic signs, and traffic lights. The maximum travelling speed 172 may be equivalent to the posted speed limit of a roadway or highway on which the autonomous vehicle 902 is travelling. Alternatively, or additionally, the maximum travelling speed 172 may depend on the location of the autonomous vehicle 902, environmental factors, and the nature of the triggering event 142 and type of degradation; a table or database of those factors and appropriate maximum travelling speed may be part of the autonomous vehicle 902, perhaps stored on the memory 126 of the control device 950. Environmental factors may include visibility (e.g., reduced visibility due to fog, sand storms, etc.), weather (e.g., precipitation, extreme temperatures, gusting winds, etc.), and road conditions (e.g., icy roads, loose gravel, metal plates, slippery or flooded roads, etc.).

During this operation, the control device 950 may parodically (e.g., two minute, every three minutes, or any other suitable time interval) receive high-level commands 174 from the oversight server 160 and navigate the autonomous vehicle 902 based on the received data.

After some time or distance depending on the remote operator 184, the remote operator 184 may issue a final high-level command 174 to pull over to a side of the road 102, change to a particular lane, or continue driving forward until reaching a particular safe area to pull over.

In certain embodiments, in the first degraded autonomy mode 140a, some communication lag between the control device 950 and the oversight server 160, such as a latency in data communication with less than a threshold latency, e.g., less than twenty seconds, fifteen, etc. is acceptable. This latency may be because one or more sensors 946 are at least partially operational. In the first degraded autonomous mode 140a, when the autonomous vehicle 902 experiences such latency, the control device 950 can use the operational sensor(s) 946 along with the adaptive cruise control 146 to help with the navigation of the autonomous vehicle 902 and lane keeping (e.g., keeping the autonomous vehicle 902 in its lane).

### Operational Flow for Implementing a Second Degraded Autonomy Mode

FIG. 3 illustrates an example operational flow 300 of system 100 of FIG. 1 for implementing the second degraded autonomy mode 140b. FIG. 3 further illustrates the road 102 travelled by the autonomous vehicle 902 where the autonomous vehicle 902 enters the second degraded autonomy mode 140b.

In the second degraded autonomy mode 140b, it is assumed that: 1) the wireless communication between the control device 950 and the oversight server 160 is at least partially operational (even with more than a threshold delay, e.g., more than half a second, a second, two seconds, etc.); 2) the adaptive cruise control 146 is at least partially operational; and 3) the control device 950 is not capable of lane following or detecting traffic signs.

The control device 950 may not be capable of lane following due to a degradation or failure that impacts the localization module 154, e.g., a hardware and/or a software degradation or failure.

The control device 950 may not be capable of detecting traffic signs due to a degradation or failure that impacts the traffic sign detection module 156, e.g., a hardware and/or a software degradation or failure.

One difference between the second degraded autonomy mode 140b and the first degraded autonomy mode 140a is that the control device 950 is less capable in its ability to navigate the autonomous vehicle 902 due to not being capable of lane following and detecting traffic signs. Thus, in the second degraded autonomy mode 140b, the control device 950 relies more on the high-level commands 174, it receives from the oversight server 160, compared to the first degraded autonomy mode 140a. Thus, in certain embodiments, the control device 950 receives high-level commands 174 more frequently compared to the first degraded autonomy mode 140a.

In an example scenario, assume that the autonomous vehicle 902 is traveling along the road 102. The control device 950 may detect an event trigger 142b that impacts the autonomous vehicle 902.

In certain embodiments, the event trigger 142b may comprise one or more of a hardware failure and a software failure with respect to the autonomous vehicle 902, similar to that described in FIG. 1.

In certain embodiments, the event trigger 142b may lead to a loss of localization capability with respect to the autonomous vehicle 902. The loss of the localization capability may lead to the control device 950 not being able to determine geographical location coordinates (e.g., GPS location coordinates) of the autonomous vehicle 902. In other words, loss of the localization capability may lead to the control device 950 not being able to determine whether the autonomous vehicle 902 is located, e.g., on the road 102 and/or on the map data 134 (see FIG. 1). The loss of the localization capability may be in response to a failure or a degradation in the localization module 154 (see FIG. 1).

In certain embodiments, the event trigger 142b may lead to a loss of traffic sign detection capability with respect to the autonomous vehicle 902. The loss of the traffic sign detection capability may lead to the control device 950 not being able to detect traffic signs and/or traffic lights, e.g., on the road 102. The loss in the traffic sign detection capability may be in response to a failure or a degradation in the traffic sign detection module 156.

In certain embodiments, the event trigger 142b may comprise a degradation in a hardware module of the autonomous vehicle 902 such that the hardware and module is partially operational, e.g., due to malfunctioning of the hardware module.

In certain embodiments, the event trigger 142b may comprise a degradation in a software module of the autonomous vehicle 902 such that the software module is partially operational, e.g., due to a bug in the software module and/or the software module being corrupted.

In certain embodiments, the event trigger 142b may comprise a degradation that impacts a hardware component of the autonomous vehicle 902, such as a sensor 946 or any component in vehicle subsystems 940 (see FIG. 9) being damaged due to an impact.

In certain embodiments, the event trigger 142b may comprise a degradation that impacts a software component of the autonomous vehicle 902, such as the software instructions 128, object detection machine learning modules 132, e.g., due to the software module being out of date.

In certain embodiments, the event trigger 142b may comprise a degradation that impacts the network interface 124. The degradation that impacts the network interface 124 may be due to the autonomous vehicle 902 being in an area where there is limited network coverage, a hardware degradation with respect to the network interface 124, and/or a software degradation with respect to the network interface 124.

### Entering the Autonomous Vehicle into the Second Degraded Autonomy Mode

In response to detecting the event trigger 142b, the control device 950 enters the autonomous vehicle 902 into the second degraded autonomy mode 140b. In the second degraded autonomy mode 140b, the control device 950 may perform one or more of the following operations in parallel or in any suitable order.

The control device 950 may communicate sensor data 130 to the oversight server 160. The sensor data 130 may comprise data that indicate objects on and around the road 102, such as lane markings, traffic signs, traffic lights, other vehicles, and/or any other object, similar to that described in FIG. 2. For example, the sensor data 130 may include a video feed captured by one or more cameras associated with the autonomous vehicle 902 (e.g., cameras 946a described in FIG. 9). In other examples, the sensor data 130 may include any other data captured by other sensors 946, such as an image feed, point cloud data feed, etc.

The oversight server 160 receives the sensor data 130. The oversight server 160 may display the sensor data 130 on the user interface 166 (see FIG. 1). The remote operator 184 may view the sensor data 130 either by accessing the oversight server 160 directly or via the application server 180 (see FIG. 1), similar to that described in FIG. 1.

The remote operator 184 may provide an input to the user interface 166 (see FIG. 1), where the input comprises one or more high-level commands 174 and the maximum traveling speed 172 for the autonomous vehicle 902. The one or more high-level commands 174 may indicate minimal risk maneuvers for the autonomous vehicle 902, such as slowing down the autonomous vehicle 902. Examples of the high-level commands 174 are described in FIG. 2.

The oversight server 160 may accept the input on the user interface 166 (see FIG. 1). The oversight server 160 may communicate the one or more high-level commands 174 and the maximum traveling speed 172 to the control device 950. The control device 950 may receive the one or more high-level commands 174 and the maximum traveling speed 172 from the oversight server 160.

The control device 950 may implement the adaptive cruise control 146 to navigate the autonomous vehicle 902. Using the adaptive cruise control 146, the control device 950 ensures that the autonomous vehicle 902 keeps a predefined safe distance with other vehicles and objects on the road 102, does not crash into the other vehicles and objects, drives in particular safe areas on the road 102 (unless overridden by a command of the remote operator 184 which may be provided in case of harmless debris on the road 102). The control device 950 may navigate the autonomous vehicle 902 using the adaptive cruise control 146 according to the one or more high-level commands 174 and the maximum traveling speed 172.

As noted above, in the second degraded autonomy mode 140b, the control device 950 may receive high-level commands 174 more frequently compared to the first degraded autonomy mode 140a, for example, every thirty seconds, every minute, or any other suitable time interval.

After some time or distance depending on the remote operator 184, the remote operator 184 may issue a final high-level command 174 to pull over to a side of the road 102, change to a particular lane, or continue driving forward until reaching a particular safe area to pull over into.

In certain embodiments, in the second degraded autonomy mode 140b, some communication lag between the control device 950 and the oversight server 160, such as a latency in data communication with less than a threshold latency, e.g., less than twenty seconds, fifteen, etc. is acceptable. However, because the control device 950 is not capable of lane following or detecting traffic signs, the remote operator 184 needs to pay extra attention to account for delay in the communication and provide high-level commands 174 so that the control device 950 does not inadvertently steer the autonomous vehicle 902 out of it intended path.

### Entering the Autonomous Vehicle from the First Degraded Autonomy Mode into the Second Degraded Autonomy Mode and Vice Versa

In certain embodiments, the control device 950 may enter the autonomous vehicle 902 from the first degraded autonomy mode 140a (see FIG. 2) into the second degraded autonomy mode 140b. For example, while the autonomous vehicle 902 is in the first degraded autonomy mode 140a (see FIG. 2), if the control device 950 determines that it is no longer capable of lane following and detecting traffic signs, it will enter the autonomous vehicle 902 into the second degraded autonomy mode 140b.

In certain embodiments, the control device 950 may enter the autonomous vehicle 902 from the second degraded autonomy mode 140b into the first degraded autonomy mode 140a (see FIG. 2). For example, while the autonomous vehicle 902 is in the second degraded autonomy mode 140b, if the control device 950 detects that at least one of the localization capability and the traffic sign detection capability of the control device 950 is partially restored, it may enter the autonomous vehicle 902 into the first degraded autonomy mode 140a. For example, the control device 950 may determine that at least one of the localization capability and the traffic sign detection capability of the control device 950 is partially restored if it determines that a software update packet for a respective degraded or failed software module is received (e.g., from the oversight server 160), and installs the software update packet.

In this case, the control device 950 may perform one or more additional operations, similar to that described in FIG. 2. In this process, the control device 950 may access the sensor data 130 that comprises data representing at least one of lane markings and traffic signs on the road 102. The control device 950 may feed the sensor data 130 to the localization module 154 (see FIG. 1) to detect the lane markings on at least one or both sides of the autonomous vehicle 902 from the sensor data 130 Similarly, the control device 950 may feed the sensor data 130 to the traffic sign detection module 156 (see FIG. 1) to detect the traffic signs (and traffic lights) on the road 102 ahead of the autonomous vehicle 902 from the sensor data 130.

The control device 950 may use the detected lane markings and traffic signs in the navigation of the autonomous vehicle 902 by the adaptive cruise control 146 according to the high-level commands 174 and the maximum traveling speed 172.

### Operational Flow for Implementing a Third Degraded Autonomy Mode

FIG. 4 illustrates an example operational flow 400 of system 100 of FIG. 1 for implementing the third degraded autonomy mode 140c. FIG. 4 further illustrates a road 102 travelled by the autonomous vehicle 902 where the autonomous vehicle 902 enters the third degraded autonomy mode 140c.

In the third degraded autonomy mode 140c, it is assumed that: 1) there is no (or very poor) network communication between the control device 950 and the oversight server 160; 2) the localization module 154 (that provides lane detection capability and location detection capability) of the control device 950 is at least partially operational; 3) the traffic sign detection module 156 (that provides traffic sign detection capability) of the control device 950 is at least partially operational; and 4) the adaptive cruise control 146 is at least partially operational.

For example, there may be no (or very poor) network communication between the control device 950 and the oversight server 160 due to the autonomous vehicle 902 being in an area where the network coverage is non-existent or very poor (e.g., the network connection throughput speed is less than a threshold, such as 1 kilobyte per minute (kbpm), 2 kbpm).

In another example, there may be no (or very poor) network communication between the control device 950 and the oversight server 160 due to a malfunction in a hardware module and/or a software module associated with the network connectivity at the control device 950, such as the network interface 124 (see FIG. 1) and/or the network communication subsystem 992 (see FIG. 9).

In another example, there may be no (or very poor) network communication between the control device 950 and the oversight server 160 due to a malfunction in a hardware module and/or a software module associated with the network connectivity at the oversight server 160, such as the network interface 164.

In an example scenario, assume that the autonomous vehicle 902 is traveling along the road 102. The control device 950 may detect an event trigger 142b that impacts the autonomous vehicle 902.

In certain embodiments, the event trigger 142b may comprise one or more of a hardware and a software failure with respect to the autonomous vehicle 902, similar to that described in FIG. 1.

In certain embodiments, the event trigger 142b may lead to a degradation in (or even loss of) connectivity with the oversight server 160 such that the control device 950 and the oversight server 160 are not able to communicate with each other.

In certain embodiments, the event trigger 142b may be a loss of connectivity between the control device 950 and the oversight server 160.

Because there is no network communication between the control device 950 and the oversight server 160, the control device 950 does not receive high-level commands 174 or the maximum traveling speed 172 from the oversight server 160. Thus, the control device 950 can only rely on the sensor data 130 and the adaptive cruise control 146 to navigate the autonomous vehicle 902.

### Entering the Autonomous Vehicle into the Third Degraded Autonomy Mode

In response to detecting the event trigger 142c, the control device 950 enters the autonomous vehicle 902 into the third degraded autonomy mode 140c. In the third degraded autonomy mode 140c, the control device 950 may perform one or more of the following operations in parallel or in any suitable order.

The control device 950 may access the sensor data 130 that comprises data that represents objects 210, lane markings 212, and traffic signs 214 on and around the road 102. The control device 950 may implement the object detection machine learning modules 132, localization modules 154, and traffic sign detection modules 156, similar to that described in FIG. 2 to detect objects 210, lane markings 212, and traffic signs 214.

The control device 950 may implement the adaptive cruise control 146 to navigate the autonomous vehicle 902. Using the adaptive cruise control 146, the control device 950 may navigate the autonomous vehicle 902 such that it stays within a current lane according to the detected lane markings, and does not steer out of the current lane. Furthermore, the control device 950 may ensure that the autonomous vehicle 902 keeps a predefined safe distance with other vehicles and objects on the road 102, and does not crash into the other vehicles and objects.

Furthermore, the control device 950 may ensure procedures to navigate the autonomous vehicle 902 according to the traffic rules on the road 102 based on detecting and analyzing the traffic signs and traffic lights (if any) on the road 102.

Furthermore, the control device 950 may use the predefined maximum traveling speed 148 in the navigation of the autonomous vehicle 902. The predefined maximum traveling speed 148 may be different from the maximum traveling speed 172 that the control device 950 receives when the autonomous vehicle 902 enters the first or second degraded autonomy modes 140a-b. For example, the predefined maximum traveling speed 148 may be at the bottom end of the speed range prescribed for the road 102 according to a speed sign on the road 102 and the traffic rules.

### Determining Whether the Connectivity with the Oversight Server is at Least Partially Restored

In certain embodiments, while navigating the autonomous vehicle 902, the control device 950 may instruct the autonomous vehicle 902 to travel a predefined distance 150, e.g., one mile, two miles, or any other suitable distance. While the autonomous vehicle 902 is traveling the predefined distance 150, the control device 950 determines whether the connectivity with the oversight server 160 is at least partially restored. For example, the control device 950 may communicate an acknowledgement request 410 to the oversight server 160 periodically, e.g., every minute, every two minutes, etc.

If the control device 950 receives a response from the oversight server 160 before a certain time, e.g., before one minute, thirty seconds, etc., it determines that the connectivity with the oversight server 160 is at least partially restored. Otherwise, it determines that the connectivity with the oversight server 160 is still not restored. The connectivity with the oversight server 160 may be restored if the autonomous vehicle 902 moves to an area where there is better network coverage.

In certain embodiments, by the end of traveling the predefined distance 150, if the control device 950 determines that the connectivity with the oversight server 160 is not at least partially restored, the control device 950 may instruct the autonomous vehicle 902 to stop in a safe area (e.g., obstacle-free area, emergency lane, etc.).

In certain embodiments, by the end of traveling the predefined distance 150, if the control device 950 determines that the connectivity with the oversight server 160 is not at least partially restored, the control device 950 may instruct the autonomous vehicle 902 to pull over to a particular location on a side of the road 102.

In this process, the control device 950 may determine if it is possible to safely pull over the autonomous vehicle 902. The control device 950 may determine that it is possible to safely pull over the autonomous vehicle 902 if traffic allows. If the control device 950 determines that it is safe to pull over the autonomous vehicle 902, it may instruct the autonomous vehicle 902 to pull over to a particular location on a side of the road 102. Otherwise, the control device 950 may instruct the autonomous vehicle 902 to stop in a safe area (e.g., obstacle-free area, emergency lane, etc.).

At the end of traveling the predefined distance 150, if the control device 950 determines that the connectivity with the oversight server 160 is at least partially restored, the control device 950 may receive one or more high-level commands 174 and maximum traveling speed 172 from the oversight server 160. In other words, the control device 950 may enter the autonomous vehicle 902 into the first degraded autonomy mode 140a described in FIG. 2.

Thus, the control device 950 may navigate the autonomous vehicle 902 using the adaptive cruise control 146 according to the one or more high-level commands 174, maximum traveling speed 172, lane markings, and traffic signs, similar to that described in FIG. 2.

In certain embodiments, while navigating the autonomous vehicle 902, the control device 950 may instruct the autonomous vehicle 902 to travel until a predefined time 152, e.g., five minutes, ten minutes, or any other suitable time period. While, the autonomous vehicle 902 is traveling until the predefined time 152, the control device 950 determines whether the connectivity with the oversight server 160 is at least partially restored, e.g., by sending acknowledgement requests 410 to the oversight server 160, similar to that described in the case above.

In certain embodiments, by the end of traveling until the predefined time 152, if the control device 950 determines that the connectivity with the oversight server 160 is not at least partially restored, the control device 950 may instruct the autonomous vehicle 902 to stop in a safe area (e.g., an obstacle-free area, an emergency lane, etc.), if it is determined that it is not possible to pull over the autonomous vehicle 902, similar to that described in the case above.

In certain embodiments, by the end of traveling until the predefined time 152, if the control device 950 determines that the connectivity with the oversight server 160 is not at least partially restored, the control device 950 may instruct the autonomous vehicle 902 to pull over to a particular location on a side of the road 102, if it is determined that it is possible to pull over the autonomous vehicle 902, similar to that described in the case above.

At the end of traveling until the predefined distance 150, if the control device 950 determines that the connectivity with the oversight server 160 is at least partially restored, the control device 950 may receive one or more high-level commands 174 and maximum traveling speed 172 from the oversight server 160. In other words, the control device 950 may enter the autonomous vehicle 902 into the first degraded autonomy mode 140a described in FIG. 2. Thus, the control device 950 may navigate the autonomous vehicle 902 using the adaptive cruise control 146 according to the one or more high-level commands 174, maximum traveling speed 172, lane markings, and traffic signs, similar to that described in FIG. 2.

### Entering the Autonomous Vehicle from a Degraded Autonomy Mode to Another

In certain embodiments, while the autonomous vehicle 902 is in the third degraded autonomy mode 140c, the control device 950 may enter the autonomous vehicle 902 into the first degraded autonomy mode 140a or second degraded autonomy mode 140b depending on the situation and whether the localization capability and the traffic sign detection capability are at least partially operational, similar to that described in FIGS. 1-3.

For example if the localization capability and the traffic sign detection capability of the control device 950 are not operational, the control device 950 may enter the autonomous vehicle 902 into the second degraded autonomy mode 140b. In another example, if the localization capability and the traffic sign detection capability of the control device 950 are at least partially operational, the control device 950 may enter the autonomous vehicle 902 in the first degraded autonomy mode 140a. Thus, the control device 950 may enter the autonomous vehicle 902 from any of the degraded modes 140a-c to another mode as needed depending on a situation and event trigger 142a-c.

Although, the present disclosure describes three degraded autonomy modes 140a-c, other degraded autonomy modes 140 may be implemented in light of the present disclosure. For example, in certain embodiments, in response to a degradation or a failure in any hardware and/or software module of the autonomous vehicle 902, a particular degraded autonomy mode 140 may be implemented to navigate the autonomous vehicle 902 without forcing the autonomous vehicle 902 to abruptly stop.

### Example Method for Implementing a First Degraded Autonomy Mode

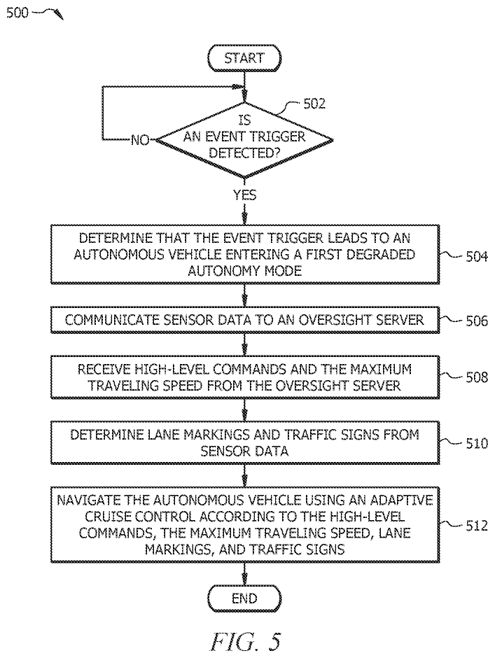

FIG. 5 illustrates an example flowchart of a method 500 for implementing a first degraded autonomy modes 140a. Modifications, additions, or omissions may be made to method 500. Method 500 may include more, fewer, or other operations. For example, operations may be performed in parallel or in any suitable order. While at times discussed as the system 100, autonomous vehicle 902, control device 950, oversight server 160, or components of any of thereof performing operations, any suitable system or components of the system may perform one or more operations of the method 500. For example, one or more operations of method 500 may be implemented, at least in part, in the form of software instructions 128, software instructions 170, and processing instructions 980, respectively, from FIGS. 1 and 9, stored on non-transitory, tangible, machine-readable media (e.g., memory 126, memory 168, and data storage 990, respectively, from FIGS. 1 and 9) that when run by one or more processors (e.g., processors 122, 162, and 970, respectively, from FIGS. 1 and 9) may cause the one or more processors to perform operations 502-512.

At operation 502, the control device 950 determines whether an event trigger 142a is detected. Examples of the event trigger 142a that may lead to the control device 950 entering the autonomous vehicle 902 into the first degraded autonomy mode 140a are described in FIG. 2. If the control device 950 determines that an event trigger 142a is detected, method 500 proceeds to operation 504. Otherwise, method 500 remains at operation 502.

At operation 504, the control device 950 determines that the event trigger 142a leads to the autonomous vehicle 902 entering the first degraded autonomy mode 140a. For example, in this case, the event trigger 142a may be one or more event triggers 142a described in FIG. 2.

At operation 506, the control device 950 communicates sensor data 130 to the oversight server 160. The sensor data 130 may include data that represent objects and obstacles on a road 102 travelled by the autonomous vehicle 902, similar to that described in FIGS. 1 and 2.

At operation 508, the control device 950 receives high-level commands 174 and the maximum traveling speed 172 from the oversight server 160. Examples of the high-level commands 174 are described in FIG. 2.

At operation 510, the control device 950 determines lane markings and traffic signs from the sensor data 130. In this process, the control device 950 may implement the object detection machine learning modules 132, localization modules 154, and traffic sign detection modules 156, similar to that described in FIGS. 1 and 2.

At operation 512, the control device 950 navigates the autonomous vehicle 902 using the adaptive cruise control 146 according to the high-level commands 174, the maximum traveling speed 172, lane markings, and traffic signs, similar to that described in FIG. 2.

### Example Method for Implementing a Second Degraded Autonomy Mode

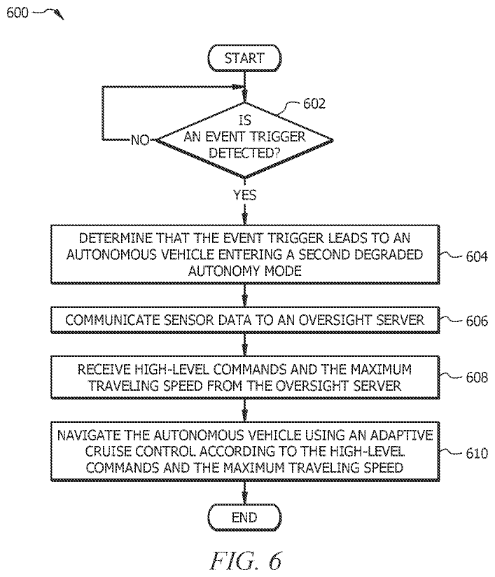

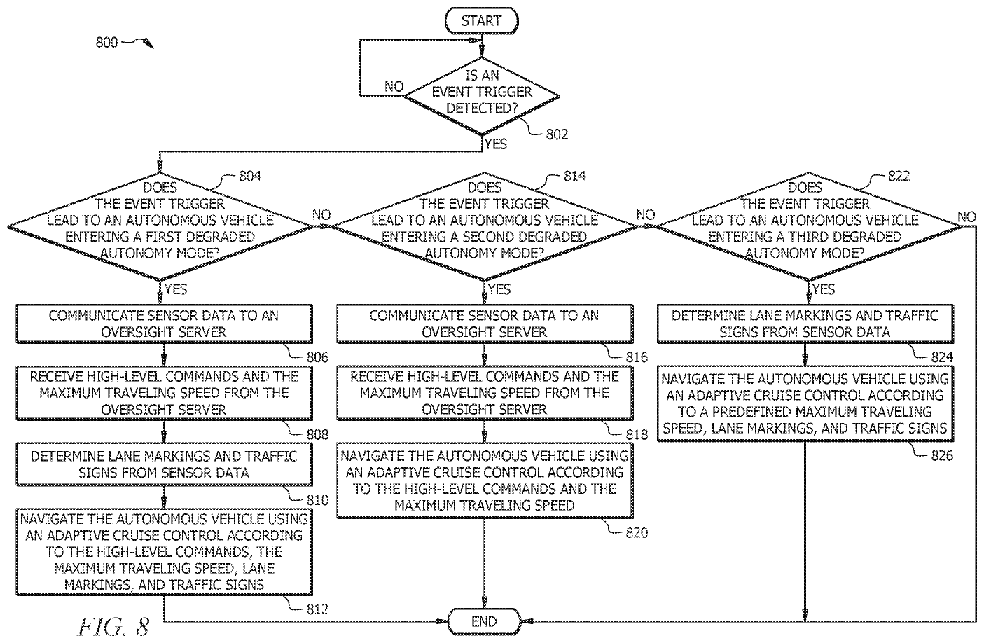

FIG. 6 illustrates an example flowchart of a method 600 for implementing a second degraded autonomy modes 140b. Modifications, additions, or omissions may be made to method 600. Method 600 may include more, fewer, or other operations. For example, operations may be performed in parallel or in any suitable order. While at times discussed as the system 100, autonomous vehicle 902, control device 950, oversight server 160, or components of any of thereof performing operations, any suitable system or components of the system may perform one or more operations of the method 600. For example, one or more operations of method 600 may be implemented, at least in part, in the form of software instructions 128, software instructions 170, and processing instructions 980, respectively, from FIGS. 1 and 9, stored on non-transitory, tangible, machine-readable media (e.g., memory 126, memory 168, and data storage 990, respectively, from FIGS. 1 and 9) that when run by one or more processors (e.g., processors 122, 162, and 970, respectively, from FIGS. 1 and 8) may cause the one or more processors to perform operations 602-610.

At operation 602, the control device 950 determines whether an event trigger 142b is detected. Examples of the event trigger 142b that may lead to the control device 950 entering the autonomous vehicle 902 into the second degraded autonomy mode 140b are described in FIG. 3. If the control device 950 determines that an event trigger 142b is detected, method 600 proceeds to operation 604. Otherwise, method 600 remains at operation 602.

At operation 604, the control device 950 determines that the event trigger 142b leads to the autonomous vehicle 902 entering the second degraded autonomy mode 140b. For example, in this case, the event trigger 142b may be one or more event triggers 142b described in FIG. 3.

At operation 606, the control device 950 communicates sensor data 130 to the oversight server 160. The sensor data 130 may include data that represent objects and obstacles on a road 102 travelled by the autonomous vehicle 902, similar to that described in FIGS. 1-3.

At operation 608, the control device 950 receives high-level commands 174 and the maximum traveling speed 172 from the oversight server 160. Examples of the high-level commands 174 are described in FIGS. 2 and 3.

At operation 610, the control device 950 navigates the autonomous vehicle 902 using the adaptive cruise control 146 according to the high-level commands 174 and the maximum traveling speed 172, similar to that described in FIG. 3.

### Example Method for Implementing a Third Degraded Autonomy Mode

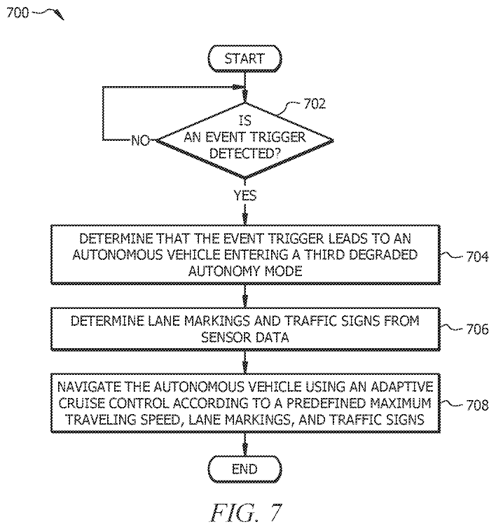

FIG. 7 illustrates an example flowchart of a method 700 for implementing a third degraded autonomy modes 140c. Modifications, additions, or omissions may be made to method 700. Method 700 may include more, fewer, or other operations. For example, operations may be performed in parallel or in any suitable order. While at times discussed as the system 100, autonomous vehicle 902, control device 950, oversight server 160, or components of any of thereof performing operations, any suitable system or components of the system may perform one or more operations of the method 700. For example, one or more operations of method 700 may be implemented, at least in part, in the form of software instructions 128, software instructions 170, and processing instructions 980, respectively, from FIGS. 1 and 9, stored on non-transitory, tangible, machine-readable media (e.g., memory 126, memory 168, and data storage 990, respectively, from FIGS. 1 and 9) that when run by one or more processors (e.g., processors 122, 162, and 970, respectively, from FIGS. 1 and 9) may cause the one or more processors to perform operations 702-708.

At operation 702, the control device 950 determines whether an event trigger 142c is detected. Examples of the event trigger 142c that may lead to the control device 950 entering the autonomous vehicle 902 into the third degraded autonomy mode 140c are described in FIG. 3. If the control device 950 determines that an event trigger 142c is detected, method 700 proceeds to operation 704. Otherwise, method 700 remains at operation 702.

At operation 704, the control device 950 determines that the event trigger 142c leads to the autonomous vehicle 902 entering the third degraded autonomy mode 140c. For example, in this case, the event trigger 142c may be one or more event triggers 142c described in FIG. 4.

At operation 706, the control device 950 determines lane markings and traffic signs from the sensor data 130. In this process, the control device 950 may implement the object detection machine learning modules 132, localization modules 154, and traffic sign detection modules 156, similar to that described in FIGS. 1 and 4.

At operation 708, the control device 950 navigates the autonomous vehicle 902 using the adaptive cruise control 146 according to a predefined maximum traveling speed 172, lane markings, and the traffic signs, similar to that described in FIG. 4.

### Example Method for Implementing Various Degraded Autonomy Modes

FIG. 8 illustrates an example flowchart of a method 800 for implementing various degraded autonomy modes 140a-c. Modifications, additions, or omissions may be made to method 800. Method 800 may include more, fewer, or other operations. For example, operations may be performed in parallel or in any suitable order. While at times discussed as the system 100, autonomous vehicle 902, control device 950, oversight server 160, or components of any of thereof performing operations, any suitable system or components of the system may perform one or more operations of the method 800. For example, one or more operations of method 800 may be implemented, at least in part, in the form of software instructions 128, software instructions 170, and processing instructions 980, respectively, from FIGS. 1 and 9, stored on non-transitory, tangible, machine-readable media (e.g., memory 126, memory 168, and data storage 990, respectively, from FIGS. 1 and 9) that when run by one or more processors (e.g., processors 122, 162, and 970, respectively, from FIGS. 1 and 9) may cause the one or more processors to perform operations 802-826.

At operation 802, the control device 950 determines whether an event trigger 142 is detected. Various examples of event trigger 142 that may lead to the control device 950 entering the autonomous vehicle 902 in various degraded autonomy modes 140a-c are described in FIGS. 1-4. If the control device 950 determines that an event trigger 142 is detected, method 800 proceeds to operation 804. Otherwise, method 800 remains at operation 802.

At operation 804, the control device 950 determines whether the event trigger 142 leads to the autonomous vehicle 902 entering a first degraded autonomy mode 140a. For example, the control device 950 may determine that the detected event trigger 142 is one or more of the event triggers 142a described in FIG. 2. If the control device 950 determines that the event trigger 142a leads to the autonomous vehicle 902 entering the first degraded autonomy mode 140a, method 800 proceeds to operation 806. Otherwise, method 800 proceeds to operation 814.

At operation 806, the control device 950 communicates sensor data 130 to the oversight server 160. The sensor data 130 may include data that represent objects and obstacles on a road 102 travelled by the autonomous vehicle 902, similar to that described in FIGS. 1 and 2.

At operation 808, the control device 950 receives high-level commands 174 and the maximum traveling speed 172 from the oversight server 160. Examples of the high-level commands 174 are described in FIG. 2.

At operation 810, the control device 950 determines lane markings and traffic signs from the sensor data 130. In this process, the control device 950 may implement the object detection machine learning modules 132, localization modules 154, and traffic sign detection modules 156, similar to that described in FIGS. 1 and 2.

At operation 812, the control device 950 navigates the autonomous vehicle 902 using the adaptive cruise control 146 according to the high-level commands 174, the maximum traveling speed 172, lane markings, and traffic signs, similar to that described in FIG. 2.

At operation 814, the control device 950 determines whether the event trigger 142 leads to the autonomous vehicle 902 entering a second degraded autonomy mode 140b. For example, the control device 950 may determine that the detected event trigger 142 is one or more of the event triggers 142b described in FIG. 3. If the control device 950 determines that the event trigger 142a leads to the autonomous vehicle 902 entering the second degraded autonomy mode 140b, method 800 proceeds to operation 816. Otherwise, method 800 proceeds to operation 822.

At operation 816, the control device 950 communicates sensor data 130 to the oversight server 160. The sensor data 130 may include data that represent objects and obstacles on a road 102 travelled by the autonomous vehicle 902, similar to that described in FIGS. 1-3.

At operation 818, the control device 950 receives high-level commands 174 and the maximum traveling speed 172 from the oversight server 160. Examples of the high-level commands 174 are described in FIGS. 2 and 3.

At operation 820, the control device 950 navigates the autonomous vehicle 902 using the adaptive cruise control 146 according to the high-level commands 174 and the maximum traveling speed 172, similar to that described in FIG. 3.

At operation 822, the control device 950 determines whether the event trigger 142 leads to the autonomous vehicle 902 entering a third degraded autonomy mode 140c. For example, the control device 950 may determine that the detected event trigger 142 is one or more of the event triggers 142c described in FIG. 4. If the control device 950 determines that the event trigger 142c leads to the autonomous vehicle 902 entering the third degraded autonomy mode 140c, method 800 proceeds to operation 824. Otherwise, method 800 ends.

At operation 706, the control device 950 determines lane markings and traffic signs from the sensor data 130. In this process, the control device 950 may implement the object detection machine learning modules 132, localization modules 154, and traffic sign detection modules 156, similar to that described in FIGS. 1 and 4.

At operation 708, the control device 950 navigates the autonomous vehicle 902 using the adaptive cruise control 146 according to a predefined maximum traveling speed 172, lane markings, and the traffic signs, similar to that described in FIG. 4.

### Example Autonomous Vehicle and Its Operation

FIG. 9 shows a block diagram of an example vehicle ecosystem 900 in which autonomous driving operations can be determined. As shown in FIG. 9, the autonomous vehicle 902 may be a semi-trailer truck. The vehicle ecosystem 900 may include several systems and components that can generate and/or deliver one or more sources of information/data and related services to the in-vehicle control computer 950 that may be located in an autonomous vehicle 902. The in-vehicle control computer 950 can be in data communication with a plurality of vehicle subsystems 940, all of which can be resident in the autonomous vehicle 902. A vehicle subsystem interface 960 may be provided to facilitate data communication between the in-vehicle control computer 950 and the plurality of vehicle subsystems 940. In some embodiments, the vehicle subsystem interface 960 can include a controller area network (CAN) controller to communicate with devices in the vehicle subsystems 940.

The autonomous vehicle 902 may include various vehicle subsystems that support the operation of autonomous vehicle 902. The vehicle subsystems 940 may include a vehicle drive subsystem 942, a vehicle sensor subsystem 944, a vehicle control subsystem 948, and/or network communication subsystem 992992. The components or devices of the vehicle drive subsystem 942, the vehicle sensor subsystem 944, and the vehicle control subsystem 948 shown in FIG. 9 are examples. The autonomous vehicle 902 may be configured as shown or any other configurations.

The vehicle drive subsystem 942 may include components operable to provide powered motion for the autonomous vehicle 902. In an example embodiment, the vehicle drive subsystem 942 may include an engine/motor 942a, wheels/tires 942b, a transmission 942c, an electrical subsystem 942d, and a power source 942e.

The vehicle sensor subsystem 944 may include a number of sensors 946 configured to sense information about an environment or condition of the autonomous vehicle 902. The vehicle sensor subsystem 944 may include one or more cameras 946a or image capture devices, a radar unit 946b, one or more temperature sensors 946c, a wireless communication unit 946d (e.g., a cellular communication transceiver), an inertial measurement unit (IMU) 946e, a laser range finder/LiDAR unit 946f, a Global Positioning System (GPS) transceiver 946g, a wiper control system 946h. The vehicle sensor subsystem 944 may also include sensors configured to monitor internal systems of the autonomous vehicle 902 (e.g., an O2 monitor, a fuel gauge, an engine oil temperature, etc.).

The IMU 946e may include any combination of sensors (e.g., accelerometers and gyroscopes) configured to sense position and orientation changes of the autonomous vehicle 902 based on inertial acceleration. The GPS transceiver 946g may be any sensor configured to estimate a geographic location of the autonomous vehicle 902. For this purpose, the GPS transceiver 946g may include a receiver/transmitter operable to provide information regarding the position of the autonomous vehicle 902 with respect to the Earth. The radar unit 946b may represent a system that utilizes radio signals to sense objects within the local environment of the autonomous vehicle 902. In some embodiments, in addition to sensing the objects, the radar unit 946b may additionally be configured to sense the speed and the heading of the objects proximate to the autonomous vehicle 902. The laser range finder or LiDAR unit 946f may be any sensor configured to use lasers to sense objects in the environment in which the autonomous vehicle 902 is located. The cameras 946a may include one or more devices configured to capture a plurality of images of the environment of the autonomous vehicle 902. The cameras 946a may be still image cameras or motion video cameras.

The vehicle control subsystem 948 may be configured to control the operation of the autonomous vehicle 902 and its components. Accordingly, the vehicle control subsystem 948 may include various elements such as a throttle and gear selector 948a, a brake unit 948b, a navigation unit 948c, a steering system 948d, and/or an autonomous control unit 948e. The throttle and gear selector 948a may be configured to control, for instance, the operating speed of the engine and, in turn, control the speed of the autonomous vehicle 902. The throttle and gear selector 948a may be configured to control the gear selection of the transmission. The brake unit 948b can include any combination of mechanisms configured to decelerate the autonomous vehicle 902. The brake unit 948b can slow the autonomous vehicle 902 in a standard manner, including by using friction to slow the wheels or engine braking. The brake unit 948b may include an anti-lock brake system (ABS) that can prevent the brakes from locking up when the brakes are applied. The navigation unit 948c may be any system configured to determine a driving path or route for the autonomous vehicle 902. The navigation unit 948c may additionally be configured to update the driving path dynamically while the autonomous vehicle 902 is in operation. In some embodiments, the navigation unit 948c may be configured to incorporate data from the GPS transceiver 946g and one or more predetermined maps so as to determine the driving path for the autonomous vehicle 902. The steering system 948d may represent any combination of mechanisms that may be operable to adjust the heading of autonomous vehicle 902 in an autonomous mode or in a driver-controlled mode.

The autonomous control unit 948e may represent a control system configured to identify, evaluate, and avoid or otherwise negotiate potential obstacles or obstructions in the environment of the autonomous vehicle 902. In general, the autonomous control unit 948e may be configured to control the autonomous vehicle 902 for operation without a driver or to provide driver assistance in controlling the autonomous vehicle 902. In some embodiments, the autonomous control unit 948e may be configured to incorporate data from the GPS transceiver 946g, the radar unit 946b, the LiDAR unit 946f, the cameras 946a, and/or other vehicle subsystems to determine the driving path or trajectory for the autonomous vehicle 902.

The network communication subsystem 992 may comprise network interfaces, such as routers, switches, modems, and/or the like. The network communication subsystem 992 may be configured to establish communication between the autonomous vehicle 902 and other systems, servers, etc. The network communication subsystem 992 may be further configured to send and receive data from and to other systems.

Many or all of the functions of the autonomous vehicle 902 can be controlled by the in-vehicle control computer 950. The in-vehicle control computer 950 may include at least one data processor 970 (which can include at least one microprocessor) that executes processing instructions 980 stored in a non-transitory computer-readable medium, such as the data storage device 990 or memory. The in-vehicle control computer 950 may also represent a plurality of computing devices that may serve to control individual components or subsystems of the autonomous vehicle 902 in a distributed fashion. In some embodiments, the data storage device 990 may contain processing instructions 980 (e.g., program logic) executable by the data processor 970 to perform various methods and/or functions of the autonomous vehicle 902, including those described with respect to FIGS. 1-11.

The data storage device 990 may contain additional instructions as well, including instructions to transmit data to, receive data from, interact with, or control one or more of the vehicle drive subsystem 942, the vehicle sensor subsystem 944, and the vehicle control subsystem 948. The in-vehicle control computer 950 can be configured to include a data processor 970 and a data storage device 990. The in-vehicle control computer 950 may control the function of the autonomous vehicle 902 based on inputs received from various vehicle subsystems (e.g., the vehicle drive subsystem 942, the vehicle sensor subsystem 944, and the vehicle control subsystem 948).

FIG. 10 shows an exemplary system 1000 for providing precise autonomous driving operations. The system 1000 may include several modules that can operate in the in-vehicle control computer 950, as described in FIG. 9. The in-vehicle control computer 950 may include a sensor fusion module 1002 shown in the top left corner of FIG. 10, where the sensor fusion module 1002 may perform at least four image or signal processing operations. The sensor fusion module 1002 can obtain images from cameras located on an autonomous vehicle to perform image segmentation 1004 to detect the presence of moving objects (e.g., other vehicles, pedestrians, etc.,) and/or static obstacles (e.g., stop sign, speed bump, terrain, etc.,) located around the autonomous vehicle. The sensor fusion module 1002 can obtain LiDAR point cloud data item from LiDAR sensors located on the autonomous vehicle to perform LiDAR segmentation 1006 to detect the presence of objects and/or obstacles located around the autonomous vehicle.

The sensor fusion module 1002 can perform instance segmentation 1008 on image and/or point cloud data items to identify an outline (e.g., boxes) around the objects and/or obstacles located around the autonomous vehicle. The sensor fusion module 1002 can perform temporal fusion 1010 where objects and/or obstacles from one image and/or one frame of point cloud data item are correlated with or associated with objects and/or obstacles from one or more images or frames subsequently received in time.

The sensor fusion module 1002 can fuse the objects and/or obstacles from the images obtained from the camera and/or point cloud data item obtained from the LiDAR sensors. For example, the sensor fusion module 1002 may determine based on a location of two cameras that an image from one of the cameras comprising one half of a vehicle located in front of the autonomous vehicle is the same as the vehicle captured by another camera. The sensor fusion module 1002 may send the fused object information to the interference module 1046 and the fused obstacle information to the occupancy grid module 1060. The in-vehicle control computer may include the occupancy grid module 1060 which can retrieve landmarks from a map database 1058 stored in the in-vehicle control computer. The occupancy grid module 1060 can determine drivable areas and/or obstacles from the fused obstacles obtained from the sensor fusion module 1002 and the landmarks stored in the map database 1058. For example, the occupancy grid module 1060 can determine that a drivable area may include a speed bump obstacle.

Below the sensor fusion module 1002, the in-vehicle control computer 950 may include a LiDAR-based object detection module 1012 that can perform object detection 1016 based on point cloud data item obtained from the LiDAR sensors 1014 located on the autonomous vehicle. The object detection 1016 technique can provide a location (e.g., in 3D world coordinates) of objects from the point cloud data item. Below the LiDAR-based object detection module 1012, the in-vehicle control computer may include an image-based object detection module 1018 that can perform object detection 1024 based on images obtained from cameras 1020 located on the autonomous vehicle. The object detection 1018 technique can employ a deep machine learning technique 1024 to provide a location (e.g., in 3D world coordinates) of objects from the image provided by the camera 1020.

The radar 1056 on the autonomous vehicle can scan an area in front of the autonomous vehicle or an area towards which the autonomous vehicle is driven. The radar data may be sent to the sensor fusion module 1002 that can use the radar data to correlate the objects and/or obstacles detected by the radar 1056 with the objects and/or obstacles detected from both the LiDAR point cloud data item and the camera image. The radar data also may be sent to the interference module 1046 that can perform data processing on the radar data to track objects by object tracking module 1048 as further described below.

The in-vehicle control computer may include an interference module 1046 that receives the locations of the objects from the point cloud and the objects from the image, and the fused objects from the sensor fusion module 1002. The interference module 1046 also receives the radar data with which the interference module 1046 can track objects by object tracking module 1048 from one point cloud data item and one image obtained at one time instance to another (or the next) point cloud data item and another image obtained at another subsequent time instance.

The interference module 1046 may perform object attribute estimation 1050 to estimate one or more attributes of an object detected in an image or point cloud data item. The one or more attributes of the object may include a type of object (e.g., pedestrian, car, or truck, etc.). The interference module 1046 may perform behavior prediction 1052 to estimate or predict the motion pattern of an object detected in an image and/or a point cloud. The behavior prediction 1052 can be performed to detect a location of an object in a set of images received at different points in time (e.g., sequential images) or in a set of point cloud data items received at different points in time (e.g., sequential point cloud data items). In some embodiments, the behavior prediction 1052 can be performed for each image received from a camera and/or each point cloud data item received from the LiDAR sensor. In some embodiments, the interference module 1046 can be performed (e.g., run or executed) to reduce computational load by performing behavior prediction 1052 on every other or after every pre-determined number of images received from a camera or point cloud data item received from the LiDAR sensor (e.g., after every two images or after every three-point cloud data items).

The behavior prediction 1052 feature may determine the speed and direction of the objects that surround the autonomous vehicle from the radar data, where the speed and direction information can be used to predict or determine motion patterns of objects. A motion pattern may comprise a predicted trajectory information of an object over a pre-determined length of time in the future after an image is received from a camera. Based on the motion pattern predicted, the interference module 1046 may assign motion pattern situational tags to the objects (e.g., “located at coordinates (x,y),” “stopped,” “driving at 50 mph,” “speeding up” or “slowing down”). The situation tags can describe the motion pattern of the object. The interference module 1046 may send the one or more object attributes (e.g., types of the objects) and motion pattern situational tags to the planning module 1062. The interference module 1046 may perform an environment analysis 1054 using any information acquired by system 1000 and any number and combination of its components.

The in-vehicle control computer may include the planning module 1062 that receives the object attributes and motion pattern situational tags from the interference module 1046, the drivable area and/or obstacles, and the vehicle location and pose information from the fused localization module 1026 (further described below).

The planning module 1062 can perform navigation planning 1064 to determine a set of trajectories on which the autonomous vehicle can be driven. The set of trajectories can be determined based on the drivable area information, the one or more object attributes of objects, the motion pattern situational tags of the objects, location of the obstacles, and the drivable area information. In some embodiments, the navigation planning 1064 may include determining an area next to the road where the autonomous vehicle can be safely parked in case of emergencies. The planning module 1062 may include behavioral decision making 1066 to determine driving actions (e.g., steering, braking, throttle) in response to determining changing conditions on the road (e.g., traffic light turned yellow, or the autonomous vehicle is in an unsafe driving condition because another vehicle drove in front of the autonomous vehicle and in a region within a pre-determined safe distance of the location of the autonomous vehicle). The planning module 1062 performs trajectory generation 1068 and selects a trajectory from the set of trajectories determined by the navigation planning operation 1064. The selected trajectory information may be sent by the planning module 1062 to the control module 1070.

The in-vehicle control computer may include a control module 1070 that receives the proposed trajectory from the planning module 1062 and the autonomous vehicle location and pose from the fused localization module 1026. The control module 1070 may include a system identifier 1072. The control module 1070 can perform a model-based trajectory refinement 1074 to refine the proposed trajectory. For example, the control module 1070 can apply filtering (e.g., Kalman filter) to make the proposed trajectory data smooth and/or to minimize noise. The control module 1070 may perform the robust control 1076 by determining, based on the refined proposed trajectory information and current location and/or pose of the autonomous vehicle, an amount of brake pressure to apply, a steering angle, a throttle amount to control the speed of the vehicle, and/or a transmission gear. The control module 1070 can send the determined brake pressure, steering angle, throttle amount, and/or transmission gear to one or more devices in the autonomous vehicle to control and facilitate precise driving operations of the autonomous vehicle.

The deep image-based object detection 1024 performed by the image-based object detection module 1018 can also be used detect landmarks (e.g., stop signs, speed bumps, etc.,) on the road. The in-vehicle control computer may include a fused localization module 1026 that obtains landmarks detected from images, the landmarks obtained from a map database 1036 stored on the in-vehicle control computer, the landmarks detected from the point cloud data item by the LiDAR-based object detection module 1012, the speed and displacement from the odometer sensor 1044 and the estimated location of the autonomous vehicle from the GPS/IMU sensor 1038 (i.e., GPS sensor 1040 and IMU sensor 1042) located on or in the autonomous vehicle. Based on this information, the fused localization module 1026 can perform a localization operation 1028 to determine a location of the autonomous vehicle, which can be sent to the planning module 1062 and the control module 1070.

The fused localization module 1026 can estimate pose 1030 of the autonomous vehicle based on the GPS and/or IMU sensors 1038. The pose of the autonomous vehicle can be sent to the planning module 1062 and the control module 1070. The fused localization module 1026 can also estimate status (e.g., location, possible angle of movement) of the trailer unit based on (e.g., trailer status estimation 1034), for example, the information provided by the IMU sensor 1042 (e.g., angular rate and/or linear velocity). The fused localization module 1026 may also check the map content 1032.

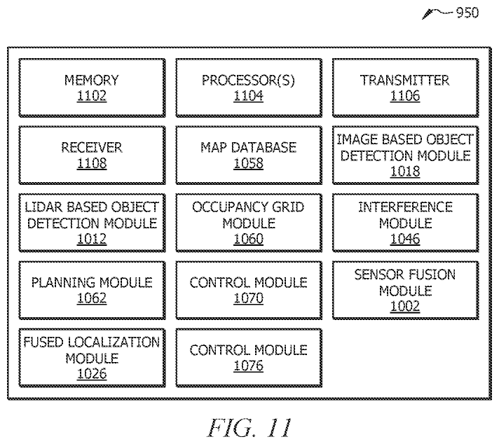

FIG. 11 shows an exemplary block diagram of an in-vehicle control computer 950 included in an autonomous vehicle 902. The in-vehicle control computer 950 may include at least one processor 1102 and a memory 1104 having instructions stored thereupon (e.g., software instructions 128 and processing instructions 980 in FIGS. 1 and 9, respectively). The instructions, upon execution by the processor 1102, configure the in-vehicle control computer 950 and/or the various modules of the in-vehicle control computer 950 to perform the operations described in FIGS. 1-11. The transmitter 1106 may transmit or send information or data to one or more devices in the autonomous vehicle. For example, the transmitter 1106 can send an instruction to one or more motors of the steering wheel to steer the autonomous vehicle. The receiver 1108 receives information or data transmitted or sent by one or more devices. For example, the receiver 1108 receives a status of the current speed from the odometer sensor or the current transmission gear from the transmission. The transmitter 1106 and receiver 1108 also may be configured to communicate with the plurality of vehicle subsystems 940 and the in-vehicle control computer 950 described above in FIGS. 9 and 10.

While several embodiments have been provided in this disclosure, it should be understood that the disclosed systems and methods might be embodied in many other specific forms without departing from the spirit or scope of this disclosure. The present examples are to be considered as illustrative and not restrictive, and the intention is not to be limited to the details given herein. For example, the various elements or components may be combined or integrated into another system or certain features may be omitted, or not implemented.

In addition, techniques, systems, subsystems, and methods described and illustrated in the various embodiments as discrete or separate may be combined or integrated with other systems, modules, techniques, or methods without departing from the scope of this disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

Implementations of the disclosure can be described in view of the following clauses, the features of which can be combined in any reasonable manner.

Clause 1. A system comprising:
an autonomous vehicle configured to travel along a road, wherein the autonomous vehicle comprises at least one sensor configured to capture sensor data;
a control device associated with the autonomous vehicle, and comprising a first processor configured to:
detect an event trigger that impacts the autonomous vehicle;
in response to detecting the event trigger, enter the autonomous vehicle into a first degraded autonomy mode, wherein in the first degraded autonomy mode, the first processor is configured to:
   communicate the sensor data to an oversight server;
   receive one or more high-level commands from the oversight server, wherein the one or more high-level commands indicate minimal risk maneuvers for the autonomous vehicle;
   receive a maximum traveling speed for the autonomous vehicle from the oversight server; and
   navigate the autonomous vehicle using an adaptive cruise control according to the one or more high-level commands and the maximum traveling speed.

Clause 2. The system of Clause 1, wherein the event trigger comprises one or more of a hardware failure and a software failure with respect to the autonomous vehicle.

Clause 3. The system of Clause 1, wherein:
the event trigger leads to a loss of localization capability with respect to the autonomous vehicle; and
the loss of the localization capability leads to the control device not being able to determine geographical location coordinates of the autonomous vehicle.

Clause 4. The system of Clause 3, wherein:
the event trigger further leads to a loss of traffic sign detection capability with respect to the autonomous vehicle; and
the loss of the traffic sign detection capability leads to the control device not being able to detect traffic signs and traffic lights.

Clause 5. The system of Clause 1, wherein the first processor is further configured to communicate a message to the oversight server that indicates the autonomous vehicle has entered the first degraded autonomy mode.

Clause 6. The system of Clause 1, further comprising the oversight server communicatively coupled with the control device, and comprising a second processor configured to:
receive the sensor data from the control device;
display the sensor data on a user interface;
accept input comprising the maximum traveling speed and the one or more high-level commands from a remote operator;
communicate the maximum traveling speed to the control device; and
communicate the one or more high-level commands to the control device.

Clause 7. The system of Clause 4, wherein the first processor is further configured to:
detect that at least one of the localization capability and the traffic sign detection capability is partially restored;
in response detecting that at least one of the localization capability and the traffic sign detection capability is partially restored, enter the autonomous vehicle into a second degraded autonomy mode, wherein in the second degraded autonomy mode, the first processor is further configured to, in addition to operations in the first degraded autonomy mode:
   access the sensor data comprising data that represents one or more of a lane marking and a traffic sign;
   detect the lane marking on at least one side of the autonomous vehicle from the sensor data;
   detect the traffic sign on the road ahead of the autonomous vehicle from the sensor data; and
   use the detected lane marking and the traffic sign in the navigation of the autonomous vehicle using the adaptive cruise control according to the one or more high-level commands and the maximum traveling speed.

Clause 8. A method comprising:
detecting an event trigger that impacts an autonomous vehicle, wherein:
the autonomous vehicle is configured to travel along a road; and the autonomous vehicle comprises at least one sensor configured to capture sensor data;
in response to detecting the event trigger, entering the autonomous vehicle into a first degraded autonomy mode, wherein in the first degraded autonomy mode, the method further comprises:
communicating the sensor data to an oversight server;
receiving one or more high-level commands from the oversight server, wherein the one or more high-level commands indicate minimal risk maneuvers for the autonomous vehicle;
receiving a maximum traveling speed for the autonomous vehicle from the oversight server; and
navigating the autonomous vehicle using an adaptive cruise control according to the one or more high-level commands and the maximum traveling speed.

Clause 9. The method of Clause 8, wherein the one or more high-level commands comprises at least one of the following instructions:
stay within a current lane for a particular amount of time;
change to a particular lane when traffic on the particular lane allows; and
pull over on a particular side of the road at a particular location.

Clause 10. The method of Clause 8, further comprising maintaining a predefined distance with other vehicles and objects on the road.

Clause 11. The method of Clause 8, the minimal risk maneuvers comprises slowing down the autonomous vehicle.

Clause 12. The method of Clause 8, wherein the autonomous vehicle is a semi-truck tractor unit attached to a trailer.

Clause 13. The method of Clause 8, wherein the sensor data comprises data that indicates objects on the road.

Clause 14. The method of Clause 8, wherein the at least one sensor comprises at least one of a camera, a light detection and ranging (LiDAR) sensor, a motion sensor, and an infrared sensor.

Clause 15. A system comprising:
an autonomous vehicle configured to travel along a road, wherein the autonomous vehicle comprises at least one sensor configured to capture sensor data;
a control device associated with the autonomous vehicle, and comprising a first processor configured to:
   detect an event trigger that impacts the autonomous vehicle;
   in response to detecting the trigger, enter the autonomous vehicle into a first autonomy degradation mode, wherein in the first autonomy degradation mode, the first processor is configured to:
      access the sensor data comprising data that represents one or more of a lane marking and a traffic sign;
      detect the lane marking on at least one side of the autonomous vehicle from the sensor data;
      detect the traffic sign on the road ahead of the autonomous vehicle from the sensor data; and
      navigate the autonomous vehicle using an adaptive cruise control such that the autonomous vehicle stays within a current lane according to the detected lane marking and obeys traffic rules according to the traffic sign, wherein navigating the autonomous vehicle is according to a predefined maximum traveling speed.

Clause 16. The system of Clause 15, wherein the event trigger comprises one or more of a hardware failure and a software failure with respect to the autonomous vehicle.

Clause 17. The system of Clause 16, wherein the event trigger leads to a degradation in connectivity with an oversight server such that the control device and the oversight server are not able to communicate with each other.

Clause 18. The system of Clause 15, wherein the event trigger is a loss of connectivity between the control device and an oversight server.

Clause 19. The system of Clause 17, wherein while navigating the autonomous vehicle comprises, the first processor is further configured to:
instruct the autonomous vehicle to travel a predefined distance;
while the autonomous vehicle is traveling the predefined distance, determine whether the connectivity with the oversight server is at least partially restored;
in response to determining that the connectivity with the oversight server is at least partially restored:
communicate the sensor data to the oversight server;
receive one or more high-level commands from the oversight server, wherein the one or more high-level commands indicate minimal risk maneuvers for the autonomous vehicle;
receive a maximum traveling speed for the autonomous vehicle from the oversight server;
navigate the autonomous vehicle using the adaptive cruise control according to the one or more high-level commands and the maximum traveling speed; and
in response to determining that the connectivity with the oversight server is not even at least partially restored, instruct the autonomous vehicle to pull over to a particular location on a side of the road.

Clause 20. The system of Clause 17, wherein while navigating the autonomous vehicle comprises, the first processor is further configured to:
instruct the autonomous vehicle to travel until a predefined time;
while the autonomous vehicle is traveling until the predefined time, determine whether the connectivity with the oversight server is at least partially restored;
in response to determining that the connectivity with the oversight server is at least partially restored:
   communicate the sensor data to the oversight server;
   receive one or more high-level commands from the oversight server, wherein the one or more high-level commands indicate minimal risk maneuvers for the autonomous vehicle;
   receive a maximum traveling speed for the autonomous vehicle from the oversight server;
   navigate the autonomous vehicle using the adaptive cruise control according to the one or more high-level commands and the maximum traveling speed; and
   in response to determining that the connectivity with the oversight server is not even at least partially restored, instruct the autonomous vehicle to pull over to a particular location on a side of the road.

Clause 21. The system of any of Clauses 1-7, wherein the first processor is further configured to perform one or more operations of a method according to any of Clauses 8-14.

Clause 22. The system of any of Clauses 15-20, wherein the first processor is further configured to perform one or more operations of a method according to any of Clauses 8-14.

Clause 23. An apparatus comprising means for performing a method according to any of Clauses 8-14.

Clause 24. A non-transitory computer-readable medium storing instructions that when executed by a processor cause the processor to perform one or more operations according to any of Clauses 1-7 and 14-20.

Clause 25. A non-transitory computer-readable medium storing instructions that when executed by a processor cause the processor to perform one or more operations according to any of Clauses 8-14.

1. A system comprising:
an autonomous vehicle configured to travel along a road, wherein the autonomous vehicle comprises at least one sensor configured to capture sensor data;
a control device associated with the autonomous vehicle, and comprising a first processor configured to:
detect an event trigger that impacts the autonomous vehicle;
in response to detecting the event trigger, enter the autonomous vehicle into a first degraded autonomy mode, wherein in the first degraded autonomy mode, the first processor is configured to:
communicate the sensor data to an oversight server;
receive one or more high-level commands from the oversight server, wherein the one or more high-level commands indicate minimal risk maneuvers for the autonomous vehicle;
receive a maximum traveling speed for the autonomous vehicle from the oversight server; and
navigate the autonomous vehicle using an adaptive cruise control according to the one or more high-level commands and the maximum traveling speed.

2. The system of claim 1, wherein the event trigger comprises one or more of a hardware failure and a software failure with respect to the autonomous vehicle.

3. The system of claim 1, wherein:
the event trigger leads to a loss of localization capability with respect to the autonomous vehicle; and
the loss of the localization capability leads to the control device not being able to determine geographical location coordinates of the autonomous vehicle.

4. The system of claim 3, wherein:
the event trigger further leads to a loss of traffic sign detection capability with respect to the autonomous vehicle; and
the loss of the traffic sign detection capability leads to the control device not being able to detect traffic signs and traffic lights.

5. The system of claim 1, wherein the first processor is further configured to communicate a message to the oversight server that indicates the autonomous vehicle has entered the first degraded autonomy mode.

6. The system of claim 1, further comprising the oversight server communicatively coupled with the control device, and comprising a second processor configured to:
receive the sensor data from the control device;
display the sensor data on a user interface;
accept input comprising the maximum traveling speed and the one or more high-level commands from a remote operator;
communicate the maximum traveling speed to the control device; and
communicate the one or more high-level commands to the control device.

7. The system of claim 4, wherein the first processor is further configured to:
detect that at least one of the localization capability and the traffic sign detection capability is partially restored;
in response detecting that at least one of the localization capability and the traffic sign detection capability is partially restored, enter the autonomous vehicle into a second degraded autonomy mode, wherein in the second degraded autonomy mode, the first processor is further configured to, in addition to operations in the first degraded autonomy mode:
access the sensor data comprising data that represents one or more of a lane marking and a traffic sign;
detect the lane marking on at least one side of the autonomous vehicle from the sensor data;
detect the traffic sign on the road ahead of the autonomous vehicle from the sensor data; and
use the detected lane marking and the traffic sign in the navigation of the autonomous vehicle using the adaptive cruise control according to the one or more high-level commands and the maximum traveling speed.

8. A method comprising:
detecting an event trigger that impacts an autonomous vehicle, wherein:
the autonomous vehicle is configured to travel along a road; and
the autonomous vehicle comprises at least one sensor configured to capture sensor data;
in response to detecting the event trigger, entering the autonomous vehicle into a first degraded autonomy mode, wherein in the first degraded autonomy mode, the method further comprises:
communicating the sensor data to an oversight server;
receiving one or more high-level commands from the oversight server, wherein the one or more high-level commands indicate minimal risk maneuvers for the autonomous vehicle;
receiving a maximum traveling speed for the autonomous vehicle from the oversight server; and
navigating the autonomous vehicle using an adaptive cruise control according to the one or more high-level commands and the maximum traveling speed.

9. The method of claim 8, wherein the one or more high-level commands comprises at least one of the following instructions:
stay within a current lane for a particular amount of time;
change to a particular lane when traffic on the particular lane allows; and
pull over on a particular side of the road at a particular location.

10. The method of claim 8, further comprising maintaining a predefined distance with other vehicles and objects on the road.

11. The method of claim 8, the minimal risk maneuvers comprises slowing down the autonomous vehicle.

12. The method of claim 8, wherein the autonomous vehicle is a semi-truck tractor unit attached to a trailer.

13. The method of claim 8, wherein the sensor data comprises data that indicates objects on the road.

14. The method of claim 8, wherein the at least one sensor comprises at least one of a camera, a light detection and ranging (LiDAR) sensor, a motion sensor, and an infrared sensor.

15. A system comprising:
an autonomous vehicle configured to travel along a road, wherein the autonomous vehicle comprises at least one sensor configured to capture sensor data;
a control device associated with the autonomous vehicle, and comprising a first processor configured to:
detect an event trigger that impacts the autonomous vehicle;
in response to detecting the trigger, enter the autonomous vehicle into a first autonomy degradation mode, wherein in the first autonomy degradation mode, the first processor is configured to:
access the sensor data comprising data that represents one or more of a lane marking and a traffic sign;
detect the lane marking on at least one side of the autonomous vehicle from the sensor data;
detect the traffic sign on the road ahead of the autonomous vehicle from the sensor data; and
navigate the autonomous vehicle using an adaptive cruise control such that the autonomous vehicle stays within a current lane according to the detected lane marking and obeys traffic rules according to the traffic sign, wherein navigating the autonomous vehicle is according to a predefined maximum traveling speed.

16. The system of claim 15, wherein the event trigger comprises one or more of a hardware failure and a software failure with respect to the autonomous vehicle.

17. The system of claim 16, wherein the event trigger leads to a degradation in connectivity with an oversight server such that the control device and the oversight server are not able to communicate with each other.

18. The system of claim 15, wherein the event trigger is a loss of connectivity between the control device and an oversight server.

19. The system of claim 17, wherein while navigating the autonomous vehicle comprises, the first processor is further configured to:
instruct the autonomous vehicle to travel a predefined distance;
while the autonomous vehicle is traveling the predefined distance, determine whether the connectivity with the oversight server is at least partially restored;
in response to determining that the connectivity with the oversight server is at least partially restored:
communicate the sensor data to the oversight server;
receive one or more high-level commands from the oversight server, wherein the one or more high-level commands indicate minimal risk maneuvers for the autonomous vehicle;
receive a maximum traveling speed for the autonomous vehicle from the oversight server;
navigate the autonomous vehicle using the adaptive cruise control according to the one or more high-level commands and the maximum traveling speed; and
in response to determining that the connectivity with the oversight server is not even at least partially restored, instruct the autonomous vehicle to pull over to a particular location on a side of the road.

20. The system of claim 17, wherein while navigating the autonomous vehicle comprises, the first processor is further configured to:
instruct the autonomous vehicle to travel until a predefined time;
while the autonomous vehicle is traveling until the predefined time, determine whether the connectivity with the oversight server is at least partially restored;
in response to determining that the connectivity with the oversight server is at least partially restored:
communicate the sensor data to the oversight server;
receive one or more high-level commands from the oversight server, wherein the one or more high-level commands indicate minimal risk maneuvers for the autonomous vehicle;
receive a maximum traveling speed for the autonomous vehicle from the oversight server;
navigate the autonomous vehicle using the adaptive cruise control according to the one or more high-level commands and the maximum traveling speed; and
in response to determining that the connectivity with the oversight server is not even at least partially restored, instruct the autonomous vehicle to pull over to a particular location on a side of the road.
